(19) United States
(12) Patent Application Publication
(10) Pub. No.: US 2008/0221923 A1
(43) Pub. Date: Sep. 11, 2008

(54) MEDICAL INFORMATION MANAGEMENT SYSTEM

(75) Inventor: Jeffrey E. Shogan, Murrysville, PA (US)

Correspondence Address: COHEN & GRIGSBY, P.C., 11 STANWIX STREET, 15TH FLOOR, PITTSBURGH, PA, 15222, US

(73) Assignee: UPMC, a corporation of the Commonwealth of Pennsylvania, Pittsburgh, PA (US)

(21) Appl. No.: 12/044,413

(22) Filed: Mar. 7, 2008

Related U.S. Application Data
(60) Provisional application No. 60/893,411, filed on Mar. 7, 2007.
(60) Provisional application No. 60/947,151, filed on Jun. 29, 2007.

(51) Int. Cl. G06Q 50/00

(52) U.S. Cl. 705/2

(57) ABSTRACT

A computer-assisted method of assisting a health care provider in diagnosing and treating a patient. The method includes preparing an event-based sequence relating to a disease for which the patient is diagnosed and treated and accepting answers from the health care provider during at least one clinical contact with the patient to a plurality of questions relating to the disease, a stage of the disease, an intervention of the disease, and a response to the intervention. The method also includes segmenting the event-based sequence into a plurality of milestone events for use by the health care provider in diagnosing and treating the patient.

### CROSS REFERENCE TO RELATED APPLICATIONS

The present application claims priority to U.S. Provisional Patent Application No. 60/893,411 filed Mar. 7, 2007 and U.S. Provisional Patent Application No. 60/947,151 filed Jun. 29, 2007.

### FIELD

Embodiments of the present invention relate to information systems, and more particularly to medical information systems.

### BACKGROUND

In a typical medical record (e.g., an electronic or paper record), information concerning a patient's history, diagnosis, test results, treatment, and response to treatment are obtained by, among other processes, extracting data from office notes, lab results, X-ray reports, etc. This bottom-up approach will theoretically capture all care information required to manage the patient. However, current representations of the data still require a clinician to synthesize the data into collections of relevant information along the clinical timeline, answering fundamental questions as to stage, intervention, and response of the disease to an intervention. Additionally, there is often not a consistent representation of these related sets of data, requiring each physician or care provider to re-establish this information across episodes and courses of care. If any synthesis of information is available, it is frequently only available in a summary paragraph in the office notes or discharge summary. In a long complicated case, extracting this information from office notes for anyone but the primary clinician can be extraordinarily difficult, and it is challenging even for the primary clinician to track. Further, data points from administrative, financial and billing are not interconnected in any meaningful way. The general lack of organized, mineable information among healthcare providers is at odds with the increasing justification requirements among healthcare insurers.

There are a large number of “task-focused” healthcare systems today that collect and store the varying types and levels of diagnostic information. In addition, many healthcare institutions have implemented Electronic Medical Records (EMRs) that collect and, to some degree, organize this information to facilitate workflow throughout the course of care for the patient. However, the prevailing systems are not effective at temporally or causally organizing the data elements with the high level clinical relevance that is required to produce an accurate and detailed electronic account of and justification for decisions pertaining to patient care.

Given that providing care to a patient, at the most basic level, is about physician analysis and decision-making and not office workflow, there is a need for an information system that supports, records, and organizes physician analysis and decision making in a clinically meaningful way to all the relevant care providers, including medical specialists.

The paradigm is shifting among insurance carriers to be more selective in their payment decisions and to focus on outcomes-oriented care. Soon, healthcare providers, for example, will only be reimbursed for a drug (often a very expensive drug) if it is approved for a particular cancer, a particular stage of that cancer, and sometimes, even a subset of the stage and disease that expresses a certain laboratory tested phenotype/genotype. Currently, there is no easy way for administrative, billing, and/or clinical personnel to ascertain or verify this electronically. Furthermore, as insurers begin paying for performance, institutions will be required to have virtual real-time access to the intervention and response for the various diseases. Capitated insurance contracts require providers to know how much they spend across multiple treatment modalities (e.g. surgery, pharmacology) to treat a particular type and stage of disease.

### SUMMARY

In a first aspect, embodiments of the present invention provide a system for managing medical patient care information organized around clinical contacts over a possibly extended time period, with hierarchical levels of information supporting a designation of a disease, a stage of the disease (which may encompass multiple events), an intervention, and a response to the intervention.

In a second aspect, embodiments of the present invention provide a method for acquiring and organizing medical patient care information hierarchically and around clinical contacts, from categories of supporting evidence, and categories of interventions. The boundaries of a clinical contact are determined by supporting evidence that is deemed relevant by a clinician, to a disease, a stage of the disease, an intervention, and a response to the intervention.

In a third aspect, embodiments of the present invention provide a method for gathering configurable levels of medical patient care information based on the patient's disease, stage of the disease, intervention, and response to the intervention. The methods may be clinically even-driven, temporally-driven, or otherwise organized to fit the needs of patients, clinicians and care providing institutions. The system can provide the ability to add new levels of information as medical knowledge evolves. The data elements can be collected through, for example, manual abstraction through a software interface, or more automated devices or methods such as extraction from external data bases or via other software elements.

In various embodiments, the present invention utilizes questions that may require synthesis and heuristic analysis. Such questions are dynamic and are not simply typical questionnaire type questions.

### BRIEF DESCRIPTION OF THE DRAWINGS

FIG. 1 is a diagram that illustrates temporally and clinically relevant data bound by a clinical contact according to various embodiments of the present invention;

FIG. 2 is a diagram that illustrates how an embodiment of the present invention, as exemplified in one embodiment into an oncology information system (OIS), fits into a healthcare information technology (HCIT) environment according to various embodiments of the present invention;

FIGS. 3a and 3b show a timeline of cancer care events according to various embodiments of the present invention;

FIG. 4 is a diagram of a workflow process for patient registration and a first office visit according to various embodiments of the present invention;

FIG. 5 is a data entry screen from the OIS for gathering required information during patient registration according to various embodiments of the present invention;

FIG. 6 is a patient status screen from the OIS according to various embodiments of the present invention;

FIG. 7 is a historical summary screen from the OIS demonstrating a rollup of supporting evidence within each bucket of required answers to four questions according to various embodiments of the present invention;

FIG. 8 is a diagram of a data model of the OIS for an initial registration and first office visit according to various embodiments of the present invention;

FIG. 9 is a diagram of a workflow process for an imaging event in which data is collected and stored in the OIS according to various embodiments of the present invention;

FIG. 10 is a radiological data entry screen from the OIS in which a user is prompted to enter, based on rules, levels of information from a diagnostic event according to various embodiments of the present invention;

FIG. 11 is a diagram of a data model of the OIS according to various embodiments of the present invention;

FIG. 12 is a diagram of a workflow process for a clinical office visit in which a health care provider uses the OIS to answer four questions according to various embodiments of the present invention;

FIG. 13 is a health care provider view screen in which a health care provider answers four questions based on data elements presented according to various embodiments of the present invention;

FIG. 14 is a historical summary screen of patient information, segmented by time and category of supporting evidence according to various embodiments of the present invention;

FIG. 15 is a diagram of a data model of the OIS according to various embodiments of the present invention;

FIG. 16 is a diagram of a workflow process for a relapse event in which a health care provider uses the OIS to answer four questions according to various embodiments of the present invention;

FIG. 17 is a health care provider view screen in which a health care provider answers four questions based on data elements presented according to various embodiments of the present invention;

FIG. 18 is a historical summary screen of patient information, segmented by time and category of supporting evidence according to various embodiments of the present invention;

FIG. 19 is a diagram of a data model of the OIS according to various embodiments of the present invention;

FIG. 20 is a diagram of a workflow process for a pathology event in which relevant diagnostic information is collected/requested and stored in the OIS according to various embodiments of the present invention;

FIG. 21 is a pathology data entry screen from the OIS in which a user is prompted to enter, based on rules, levels of information from the diagnostic event according to various embodiments of the present invention;

FIG. 22 is a diagram of a data model according to various embodiments of the present invention;

FIG. 23 is a diagram of a workflow process for a surgical event in which relevant treatment information is collected/requested and stored in the OIS according to various embodiments of the present invention;

FIG. 24 is a healthcare provider view screen in which a health care provider answers four questions based on data elements presented according to various embodiments of the present invention;

FIG. 25 is a historical summary screen of patient information, segmented by time and category of supporting evidence according to various embodiments of the present invention;

FIG. 26 is a diagram of a data model according to various embodiments of the present invention;

FIG. 27 is a diagram of a workflow process for a chemotherapy event in which relevant treatment information is collected/requested and stored in the OIS according to various embodiments of the present invention;

FIG. 28 is a diagram of a data model according to various embodiments of the present invention;

FIG. 29 is a diagram of a workflow process for a radiation therapy event in which relevant treatment information is collected/requested and stored in the OIS according to various embodiments of the present invention;

FIG. 30 is a diagram of a data model according to various embodiments of the present invention;

FIG. 31 is a diagram of an overall data model for the OIS according to various embodiments of the present invention;

FIG. 32 is a schematic representation of a data structure according to various embodiments of the present invention;

FIG. 33 is a schematic representation of an oncology information system according to various embodiments of the present invention;

FIG. 34 is a diagram of a data model according to various embodiments of the present invention;

FIG. 35 illustrates a flowchart of a method performed according to various embodiments of the present invention;

FIG. 36 illustrates a data model that can be used in conjunction with the embodiments of the systems and methods described herein;

FIG. 37 illustrates a flow of data through the systems described herein according to various embodiments of the present invention;

FIG. 38 illustrates a system diagram according to various embodiments of the present invention; and

FIGS. 39-42 illustrate flowcharts of methods performed according to various embodiments of the present invention.

### DETAILED DESCRIPTION

Embodiments of the present invention organize relevant clinical information along a clinical event-based progression (e.g., a forward or backward transition from one status to another status), series, order, sequence, and/or timeline covering the course of a disease. The information is organized in clinical information windows, each including an indication of the disease, the stage of the disease, intervention (i.e., how is it being treated?), and a description of the patient's and disease's response(s) to the intervention. The differentiation of the response of the disease and the response of the patient (e.g., toxicity) is important from both a patient care and analytics perspective. Embodiments of the invention link pertinent pieces of otherwise possibly disconnected “floating” data and facilitate the analytics needed to improve patient care. In one example, this analytic research provides valuable data over time on the diagnosis and treatment of cancer patients. Embodiments of the systems and methods described herein are illustrated using various medical applications such as oncology. It can be understood that embodiments of the invention are not limited to such examples and are instead applicable to any type of medical application such as multi-clinical-contact medical applications.

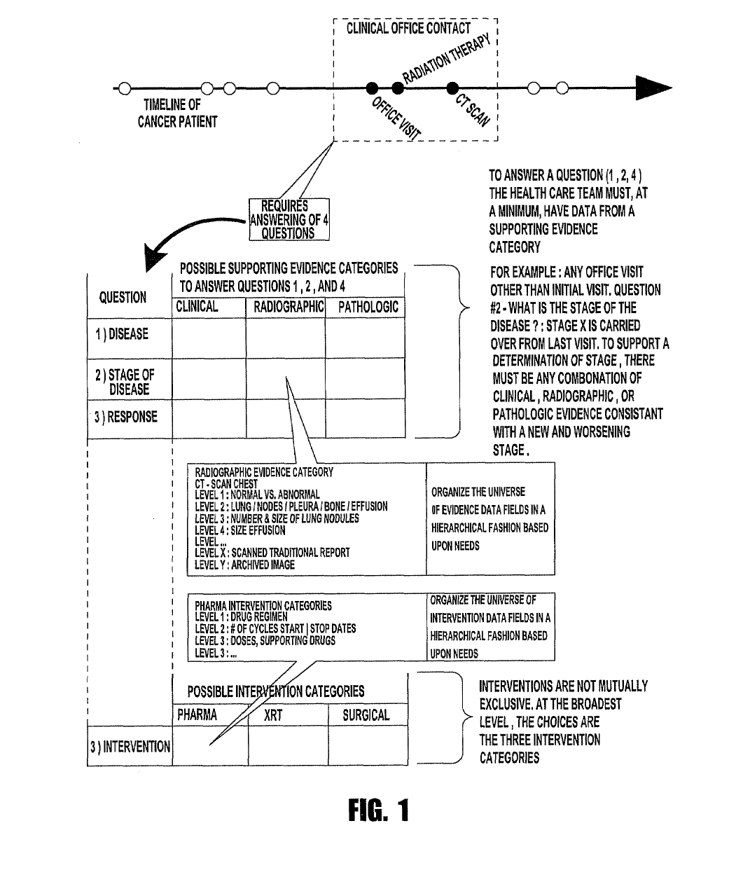

Embodiments of the system disclosed herein use a series of four fundamental questions that must be answered for each clinical contact: 1) What is the disease? 2) What is the stage (or progression) of the disease? 3) What is the intervention? 4) What is the response to the intervention? The answer options and required supporting data fields are driven by a programmable decision engine, logic engine, or rule-based engine to facilitate programmability and inspectability. The data elements that are required to support an answer to the questions are some subset (level) of available clinical, radiographic, and pathologic information, the three categories of “supporting evidence”. This is illustrated in the data boundary diagram of FIG. 1. Based on the configuration of the rules, the system either requests the level of data through an interface with the “supporting evidence” system or submits to a queue, a request for data to be manually entered. In both cases, the required data elements are stored with the appropriate temporal, causal and other clinical relevance, providing an accurate account of patient care and the decision-making process surrounding it. These data boundaries are flexible in configuration, allowing the user to configure the temporal, event-driven processes (e.g., disease diagnosis, disease stage determination, selected interventions, and resulting responses), and all other items of clinical relevance in alignment with their healthcare workflow.

For example, a Computed Tomography scan of the chest (CT-Chest) contains an extraordinary amount of information, much of which is not relevant to a specialist or to the disease status of the patient in question. Information regarding bone density, coronary artery calcifications, rotator-cuff injury, etc. does not immediately facilitate care if the disease being managed is cancer. It is stored and available for reference in both report and visual format. However, at a most basic level, level 1, the CT_Chest should be noted to show either evidence of cancer or no evidence of cancer. Level 2 through n provide further detail as to the evidence of cancer and are specific to the disease, stage/status, and intervention (pharmacologic, radiation [XRT], surgery). Level 2 data from a CT-Chest for a stage IV breast cancer patient would be very different than for a multiple myeloma patient. Furthermore, a pharmacologic intervention, which is associated with a unique toxicity (e.g., Taxanes and fluid retention in adjuvant treatment of breast cancer) may require a level 2 field regarding evidence of plural and/or pericardial effusion.

Embodiments of the present invention utilize custom system logic, embodied as rules that require and organize data elements from supporting evidence categories (clinical, radiographic, and pathologic). By forcing the clinician (health care provider) to consistently answer each of the four questions around clinical contacts, the customized system rules identify the levels of information required to support each of the answers. Relevant supporting evidence generated during events before and after the clinical office visit is connected by the clinical team to that visit through the answers to the four questions. This results in hierarchically organized supportive evidence, segmented into meaningful intervals. Flexible boundaries around each clinical contact and the ability to add to the levels (e.g., new level 2=old level 2+level n) allow for rapid evolution in response to the increased understanding of diseases.

While embodiments of the present invention can be applied across any specialty disciplines such as, for example, cardiology and geriatrics, the following demonstrates how such embodiments can be used in oncology as a non-limiting example. Embodiments of the system described herein, when used in connection with oncology, are referred to herein as the OIS (Oncology Information System).

In various embodiments, the information system can:
Create data relationships between care events and test results;
Segment the sets of data by clinical visit and status of disease;
Provide a mechanism for a privileged user to develop rules that assign relevancy to data elements, establishing a hierarchical organization of information;
Provide a mechanism for a privileged user to enable the rules, as needed, across all functions of the system;
Based on status of disease, provide relevant treatment protocol options; and
Based on status of disease, require certain supportive evidence testing.

By providing these functions through a health care provider focused, care management application, patient care information can have relationships that do the following:
Improve patient safety and clinical performance through protocol-driven standards of care;
Report on patient and disease outcomes;
Measure, monitor, and improve efficiency and financial performance;
Support focused studies; and/or
Provide real-time access to relevant clinical data.

In a first aspect, embodiments of the invention require that the following set of four questions be answered repetitively for each clinical contact, thereby segmenting the timeline into meaningful intervals:

1) What is the disease?

2) What is the stage?

3) What is the intervention?

4) What is the response?

Embodiments of the invention can be used to manage information relating to various diseases. In the non-limiting example described below, the invention is applied to an oncology setting.

Disease type can be, for example, a type of cancer. In previous systems, the disease type information is available in the patient's paper chart/EMR, as well as in various task-focused systems (such as pathology, imaging and registration, scheduling and billing/practice management). In embodiments of the system of the present invention, this information can be entered and updated by the health care provider (e.g., the treating physician) or interfaced from an existing database.

In a cancer information system, the stage of the disease indicates, among other factors, the extent to which the cancer cells have spread within the patient. In previous systems, the stage information may be available in the patient's paper chart/EMR, as well as in various task-focused systems (such as pathology, imaging and registration, scheduling and billing/practice management or months later, in a cancer registry). In embodiments of the system of the present invention, the information can be entered and updated by a health care provider (e.g., the treating physician) or loaded from an existing database, or collected and organized by a software engine from information in multiple sources.

By way of example, intervention refers to the type of treatment provided to the patient. Pharmacological (e.g., chemotherapy), radiation therapy, and surgery are the three major types of intervention used in treating cancer. These and other interventions can be subdivided based on the drug type/technique and/or methodology. For example, lumpectomy is an intervention type that is a kind of surgery. The intervention-type information may be available in the patient's paper chart/EMR. The information can be entered and updated by the health care provider (e.g., the treating physician) through a limited set of choices based on the current disease and stage. The intelligence for limiting the choices allows for integration with databases of clinical trials, protocol based treatment planning (pathways), and guidelines. Further levels of detail pertaining to the choices can be made available. For example: The first level key data for pharmacological therapy can be drugs, dose and frequency. The second level data can be toxicity and level of toxicity information. The third level data can be the drugs given to reduce the toxicity. These levels can be privileged user-programmable as needed. Access to a full range of choices may also be accessible, but may require additional documentation regarding the reason for use.

The response indicates how the disease is responding to the intervention. In one example of the system described herein, the response is classified into seven different types: initiation, remission, partial response, progression, no response, relapse and unable to assess. Currently, the response information may be available in the patient's paper chart/EMR, as well as in various task-focused systems. In embodiments of the system of the present invention, the information can be entered and updated by the health care provider (e.g., the treating physician) and required to be supported with data from “supporting evidence” systems such as radiology and pathology. The response also includes the response of the patient to treatment, including any negative responses, toxicity, etc.

During each clinical contact, each of the four questions are reaffirmed or updated. In various embodiments, for questions 1 (disease), 2 (stage), and 4 (response), the answer must be supported by information received though diagnostics such as: clinical exams (history and physical exam), imaging (radiographic, other visualization), and pathologic (blood, serum, and tissue). By associating these diagnostic results with the answers to questions 1, 2, and 4, these data elements are made relevant to a time boundary of information supporting a diagnosis of a particular malignancy (e.g., breast cancer), the stage of the breast cancer, and how well the patient is responding (shrinking/toxicity). For question 3 (intervention), the broad choices are pharmacologic, radiation, and surgical. By answering question 3, a relationship is created between the technique(s)/drug(s) used, the status of the disease, and the response of that treatment bound within the existing relevant timeline.

Answers to all four questions are supported with a level of detailed data identified through a cost/value analysis and enforced through a programmable rules engine. In various embodiments, the scope of the logic illustrated and embodied by, for example, rules is flexible enough to fine-tune the granularity based on current and future needs. In some instances, discrete data elements of high value may need to be abstracted from analog output of external systems and therefore, the system can allow for this type of manual data input.

The disease, stage and response are supported by imaging, pathological and clinical information. While assessment of patients is a common concept, embodiments of the OIS described herein identify explicitly the supporting information that is leading to the assessment. In order to effectively assess the stage of the disease in the patient, various embodiments include a requirement for additional, relevant data (for example, a flagging option within the OIS application to order specific imaging or pathology tests) and to enter/link the results to the application in time for a clinical office visit.

In one example, embodiments of the present invention include the following features:

1. The same set of four questions is used to clinically segment the timeline of the disease. The segmenting can be implemented using relevant milestone-type criteria which the specific user population of cancer clinician, consultant, or internist would find most important.

2. The boundary points on the timeline are flexible, and determined by information deemed relevant to the clinical contact. For example, various dates of a CT scan, needle biopsy, ultrasound, etc. can be used for supporting evidence during the clinical visit to diagnose the disease and stage. They can also be used to support the status of the response.

3. The forcing of boundary development gives relevance to otherwise “floating” data sets in pathology, radiology, drug usage, supportive care, etc. This enables the data to be put in a structured format (such as computer-readable table) vs. analog or other unstructured forms. It also enables the data to be hierarchically organized based on importance and/or need. The tiered data can be navigated by the health care provider to drill into as much detail as is required. For example, linking a CT scan as supporting evidence to diagnose the disease and stage ties that data to the diagnosis. Also, providing the detailed CT scan data in a tiered maimer allows the health care provider to navigate to the amount of detail required.

4. Disease, stage, intervention, and response are used as the guiding themes to segment the timeline and provide relevance to other data sets. This process can provide meaningful core data to which other modules can be interconnected. For example, billing for a drug can be associated with the treatment of a specific stage of cancer that yielded a particular response.

5. Boundaries around clinical office visits can be created by linking tests around one visit (clinical, imaging or pathologic) with a related visit. The tests are designed to diagnose disease/stage or measure response of the disease and the patient to the chosen intervention. Thus, tests that support key pieces of information associated with a visit (e.g., disease/stage and response) become part of the visit boundary. Boundaries spanning multiple, contiguous visits can be aggregated into a “status window.” A transition from one status window to another may involve a significant change in response to an intervention (e.g., partial remission to remission) or in the disease/stage (e.g., relapse following a period of remission).

6. Specific rules for what constitutes status-window changes can be specified in the OIS through a privileged user, programmable rules engine. There is a series of disease/stage-specific rules that interact with various, relevant intervention options for that disease/stage. For instance, clinical pathways can be used to encode one set of disease/stage-specific rules.

7. A set of meta-rules can be used to dictate when and how to apply the disease/stage-specific rules. In general, meta-rules regulate the contextual relevance of applying sets of rules. This method can provide, among other things:
Clinically-relevant context;
a framework for conflict resolution for selecting the most appropriate rule(s) to apply (when multiple disease/stage-specific rules are triggered, leading to multiple, possibly conflicting actions);
a notion of the importance of applying different rules at certain disease/stage-specific situations;
the ability to control clinical goals (e.g., cure vs. palliative care); and/or
an exception-processing framework (e.g., apply dose-reduction schema 1 when toxicity grade>3, but otherwise leave standard dosage).

8. Disease/stage-specific rules can also dictate which tests to require based on various factors such as disease, stage, and responses (of disease and patient) to past and recent interventions, as well as recent tests performed. Such guidance can help to optimize the timing and quantity of tests and can serve as another dimension along which care is standardized.

9. Patient or patient-subpopulation specific rules can change the preferences or priorities of intervention recommendation and interpretations of responses.

10. The framework can also be extended to other specialties: e.g., cardiovascular, musculoskeletal. The stage may be replaced in some instances by acuteness (of disease) or other similar metrics. Methodically tabulating interventions and responses (including adverse events or toxicities) can provide a valuable database from which to perform outcomes analysis or to elicit fiscal trade-offs, when combined with billing/cost information.

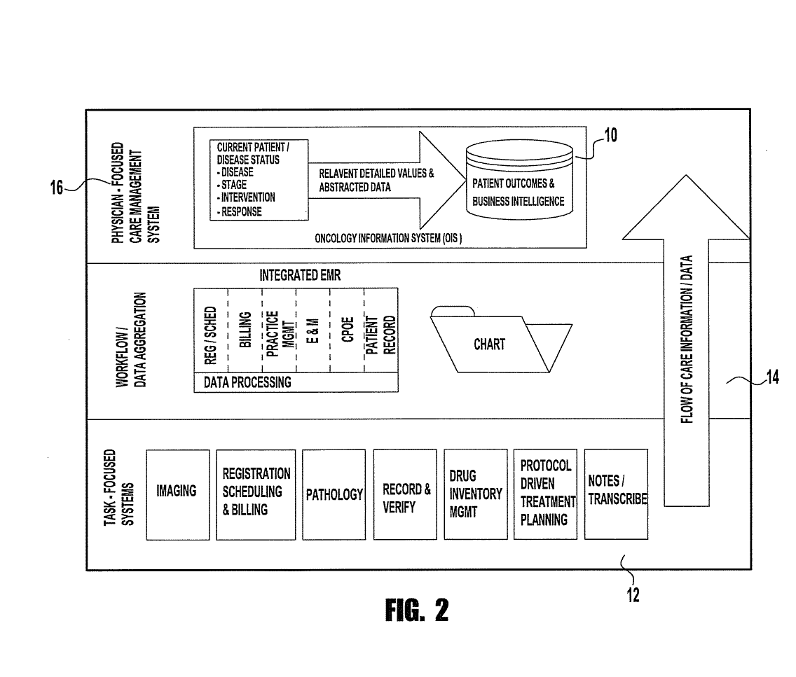

FIG. 2 is a diagram that illustrates how the system 10 of embodiments of the present invention can fit into a healthcare information technology (HCIT) environment. FIG. 2 shows the flow of care information/data from task-focused systems 12 to workflow/data aggregation 14, to a health care provider-focused care management system 16.

The following description illustrates how the system 10 can be used during the course of care. By way of illustrative example, it follows a patient through several clinical contacts and shows how data is accessed, abstracted, and accumulated into time boundaries.

Often in oncology, many patients are treated and followed for long periods of time (sometimes spanning several decades). Thus, there may be dozens of care events such as clinical office visits, infusion sessions, and radiation-therapy sessions, and several other events making up the profile of the patient. Setting boundary conditions to structure relevant information is one of the heuristics associated with the system 10.

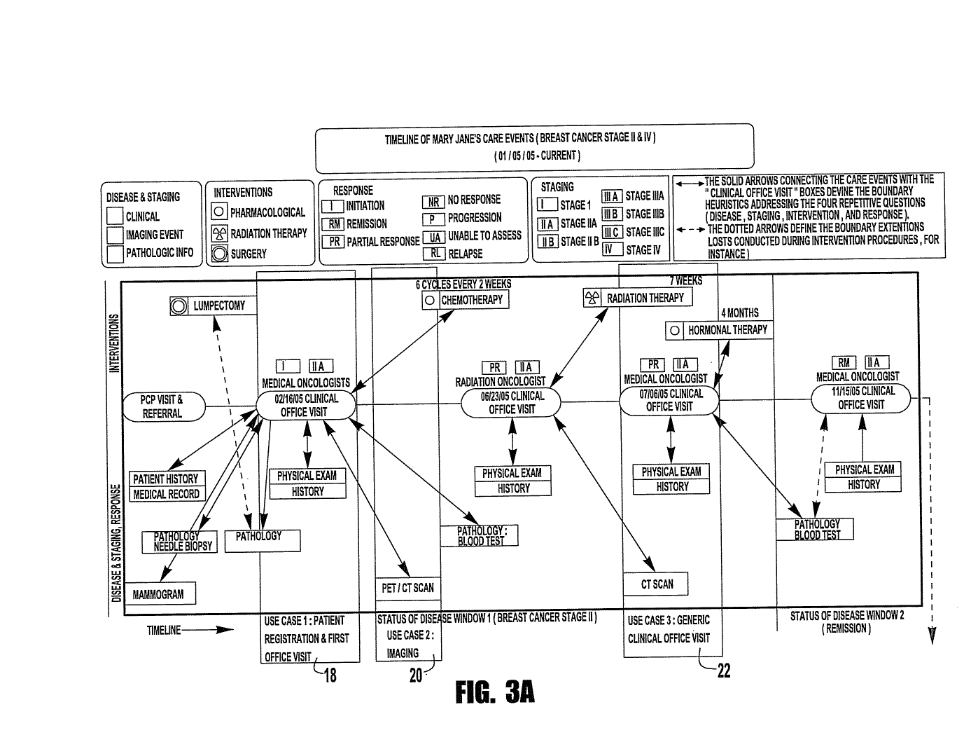

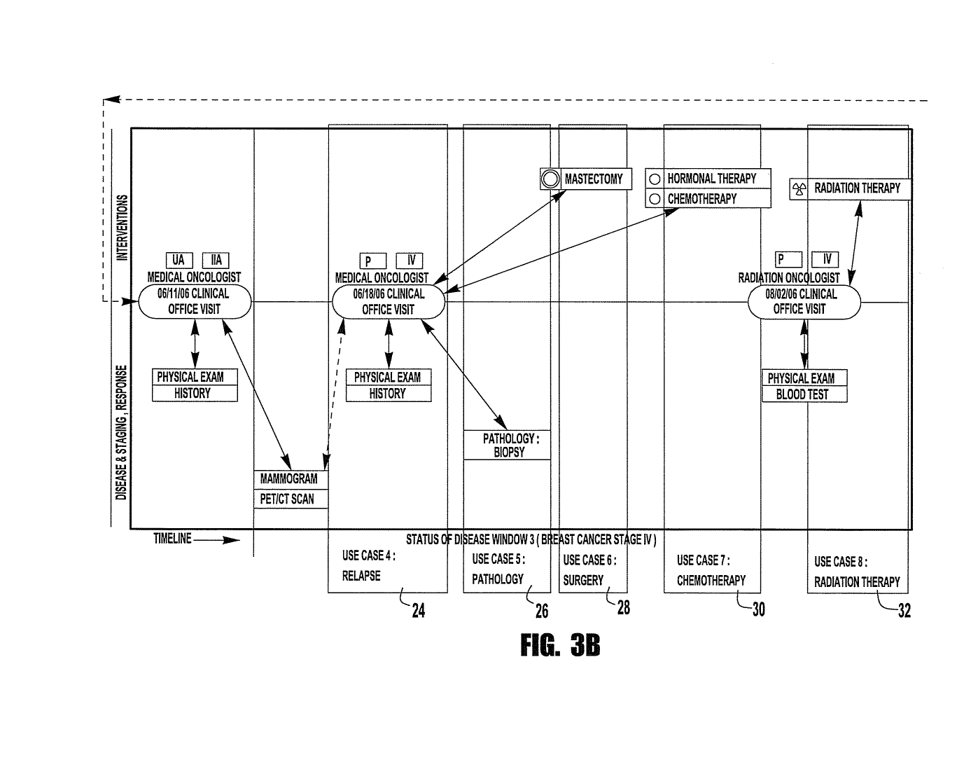

FIGS. 3a and 3b show a timeline of care events. For purposes of illustrating how the OIS 10 is used during the course of care and without limiting the embodiments of the present invention, the timeline represents events in which a fictitious character, Mary Jane, received care for breast cancer. Each clinical contact with an oncologist provides an opportunity to reiterate or update the status of disease. Answering the basic four questions around disease, stage, intervention and response (including toxicity) provides a uniform way to structure timeline intervals whose length is variable, but endpoints may be inflection points, i.e., points in time where there is a significant change in the status of a patient. A series of clinical contacts underlies each (variable length) status of disease interval, wherein there may be small changes in the status of the patient.

Each diagnostic or response measurement test can be associated with one or more outpatient clinical contact(s) to further structure the data (see solid arrows in FIGS. 3a and 3b). The boundary associated with a visit can also be extended to auxiliary tests done while performing a related care event (e.g., a blood test during a chemotherapy session). These are depicted as dashed arrows in FIGS. 3a and 3b.

This event-driven (as opposed to pure calendar-driven) methodology superimposed with the status of disease and patient framework provides a uniform, normalized way to perform the different kinds of analysis necessary to answer individual and aggregate queries relating to patient outcomes and to gauge fiscal and operational metrics.

In one example, focusing on Breast Cancer Stages II and IV, the system 10 is divided into a number of different clinical contacts that a patient would go through, for example:

1) Patient Registration and First Office Visit 18: Patient Mary Jane (name chosen purely for illustration, rather than to refer to a past or present patient) is referred to a surgeon and medical oncologist by her primary care physician (PCP), based on a lump in her breast and suspicion of Stage II breast cancer. A slice in the timeline is defined or elaborated, where the medical/radiation oncologist confirms diagnosis/stage and chooses interventional procedures, following lumpectomy by the surgeon.

2) Imaging 20: Images can remain natively resident in an imaging database and abstracted information can be linked to the system.

3) Generic Clinical Office Visit 22: A slice in the timeline can be elaborated where the medical/radiation oncologist confirms diagnosis/stage and chooses interventional procedures.

4) Relapse 24: Mary Jane suffers a relapse and is diagnosed with metastatic breast cancer.

5) Pathology 26: Pathology test results can be entered into appropriate databases.

6) Surgery 28: Details of surgery and any post-surgery summaries (including any associated toxicities) can be linked to the system 10.

7) Chemotherapy 30: Following surgery for Mary Jane, a course of chemotherapy and radiation is suggested. The timeline can be elaborated to provide details of drugs and dosage. Also, the different data items pertaining to the system 10 can be updated as part of the natural workflow.

8) Radiation Therapy 32: Mary Jane is treated with a course of radiation treatment.

FIGS. 3a and 3b illustrate the various tests and treatment methods tied to a visit. Since various test(s) and treatment options are prescribed based on a specific patient order, FIGS. 3a and 3b illustrate how “floating” data elements are linked to a clinical office visit where the four questions (disease, stage, intervention, and response) are recorded.

For example, assume that Mary Jane, a 63-year old post-menopausal woman, is presented with an abnormal mammogram. The diagnostic mammogram from Jan. 5, 2005 showed a spiculated mass at the one o'clock position of the left breast. On examination by the primary care physician (PCP), there was a palpable mass. The PCP referred Mary to surgical and medical oncologists for further evaluation and treatment.

Here, via a number of illustrative use cases relating to Mary Jane's care, the following description provides details associated with:
high-level workflow,
key process steps,
abstraction of information relevant to the OIS 10,
data elements (including their level, generic cost and disease/stage-specific value),
candidate user interface(s), and
detailed data model.

Together, they constitute an embodiment of the oncology information system 10, from which high-value knowledge pertaining to various clinical, fiscal, operational and patient-satisfaction metrics can be elicited and reported. Table 1 shows various sample and representative but not exhaustive lists of data elements that can be used in the OIS 10.

TABLE 1
OIS Data Elements

| | | | | | | | Create/Update/ |
|---|---|---|---|---|---|---|---|
| Data Field | Disease | Stage | Level | Cost | Value | Source System | Read-Only |
| Name | None | | 1 | L | H | Registration, Scheduling | Read-Only |
| | | | | | | & Billing | |
| Sex | None | | 1 | L | H | Registration, Scheduling | Read-Only |
| | | | | | | & Billing | |
| Birth date | None | | 1 | L | H | Registration, Scheduling | Read-Only |
| | | | | | | & Billing | |
| SSN | None | | 1 | L | H | Registration, Scheduling | Read-Only |
| | | | | | | & Billing | |
| Patient | None | | 1 | L | H | Registration, Scheduling | Read-Only |
| number | | | | | | & Billing | |
| Address | None | | 1 | M | L | Registration, Scheduling | Read-Only |
| | | | | | | & Billing | |
| City State Zip | None | | | | | Registration, Scheduling | Read-Only |
| | | | | | | & Billing | |
| County | None | | 1 | L | M | Registration, Scheduling | Read-Only |
| | | | | | | & Billing | |
| Marital Status | | | | | | Registration, Scheduling | Read-Only |
| | | | | | | & Billing | |
| Race | | | 1 | L | M | Registration, Scheduling | Read-Only |
| | | | | | | & Billing | |
| Primary Care | None | | 1 | L | H | Registration, Scheduling | Read-Only |
| Provider | | | | | | & Billing | |
| Provider | None | | 1 | L | H | Registration, Scheduling | Read-Only |
| History | | | | | | & Billing | |
| Employer | None | | 1 | L | M | Registration, Scheduling | Read-Only |
| | | | | | | & Billing | |
| Occupation | None | | 1 | L | H | Registration, Scheduling | Read-Only |
| | | | | | | & Billing | |
| Patient Type | | | 1 | L | H | Registration, Scheduling | Read-Only |
| | | | | | | & Billing | |
| Patient Status | | | 1 | L | H | Registration, Scheduling | Read-Only |
| | | | | | | & Billing | |
| Date of Death | | | 1 | L | M | Registration, Scheduling | Read-Only |
| | | | | | | & Billing | |
| Documents | | | 1 | L | H | Registration, Scheduling | Read-Only |
| | | | | | | & Billing | |
| Guarantor | | | 1 | L | L | Registration, Scheduling | Read-Only |
| Relationship | | | | | | & Billing | |
| to Patient | | | | | | | |
| Primary | | | 1 | L | H | Registration, Scheduling | Read-Only |
| Claim info | | | | | | & Billing | |
| Guarantor | | | 1 | L | L | Registration, Scheduling | Read-Only |
| Account | | | | | | & Billing | |
| Coverage | | | | | | | |
| Payor/Plan | | | 1 | L | H | Registration, Scheduling | Read-Only |
| | | | | | | & Billing | |
| Active | | | 1 | L | H | Registration, Scheduling | Read-Only |
| | | | | | | & Billing | |
| Account type | | | 1 | L | L | Registration, Scheduling | Read-Only |
| | | | | | | & Billing | |
| Account | | | 1 | L | L | Registration, Scheduling | Read-Only |
| status | | | | | | & Billing | |
| Benefit Plan | | | 1 | L | L | Registration, Scheduling | Read-Only |
| | | | | | | & Billing | |
| Group | | | 1 | L | L | Registration, Scheduling | Read-Only |
| Number | | | | | | & Billing | |
| Financial | | | 1 | L | L | Registration, Scheduling | Read-Only |
| Class | | | | | | & Billing | |
| Date | | I | 1 | L | H | Imaging | Read-Only |
| Normal/ | Breast | II | 1 | L | H | Imaging | Create/Read- |
| Abnormal | Cancer | | | | | | Only |
| Pathology | Breast | II | 2 | L | H | Imaging | Create/Read- |
| Reports | Cancer | | | | | | Only |
| Imaging | Breast | II | 2 | L | H | Imaging | Create/Read- |
| Reports | Cancer | | | | | | Only |
| Image | Breast | II | 3 | L | H | Imaging | Create/Read- |
| | Cancer | | | | | | Only |
| Summary | Breast | II | 2 | L | H | Imaging | Create/Read- |
| | Cancer | | | | | | Only |

Table 2 shows cost and value descriptions for low, medium and high designations that can be applied to the data elements of Table 1.

TABLE 2

| Legend | Cost | Value |
|---|---|---|
| Low (L) | Data is either known by user or already exists in a | Adds little value to the use of |
| | database with an existing standard interface | the OIS system |
| Medium (M) | Data exists in >1 systems and/or unique to | Adds ability to produce |
| | specialty; or is abstracted by low-cost resource | performance/other measures |
| High (H) | Data is only available in raw analog format and | Required to answer one of the |
| | will need to be abstracted by a licensed | four questions or impacts |
| | professional. Data is extremely large, etc. | revenue |

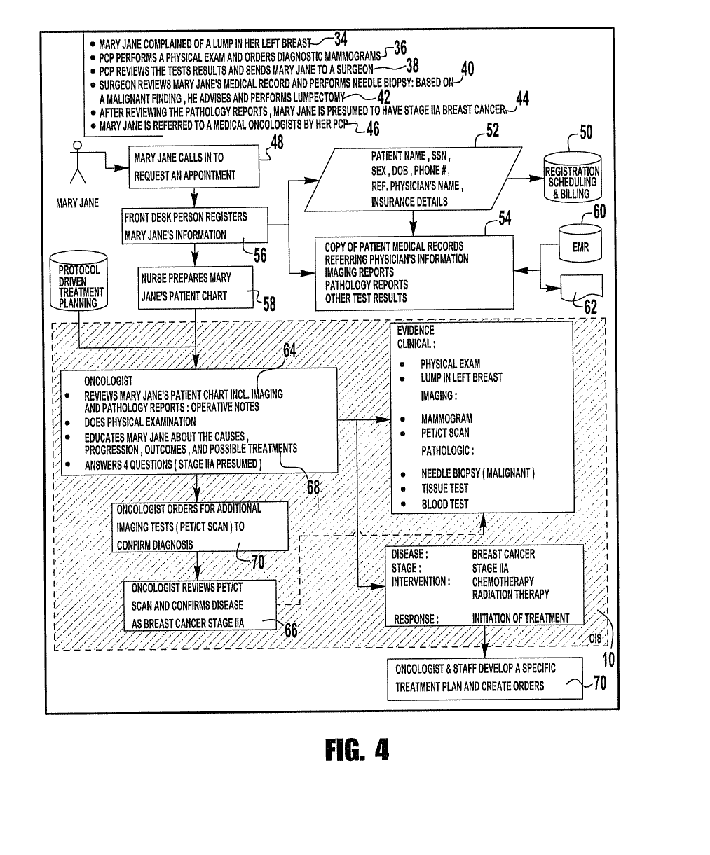

FIG. 4 is a diagram of a workflow process for patient registration and a first office visit 18. In an illustrative example of a patient registration and first office visit use case, the following pre-conditions are considered.
Mary Jane complained of a lump in her left breast to her PCP 34.
PCP performed physical exam and ordered a diagnostic mammogram 36.
PCP reviewed the mammogram test results and referred Mary Jane to a surgeon 38.
Surgeon reviews Mary Jane's medical record and orders a needle biopsy 40.
Needle biopsy shows evidence (malignant tumor) of cancer; PCP orders lumpectomy 42.
Pathology reports and results are reviewed and Mary Jane is diagnosed with Stage II Breast Cancer 44.
PCP refers Mary Jane to an oncologist 46.

The process steps associated with this case include:
Mary Jane calls a medical oncologist clinic to request an appointment 48. The patient name is provided and a search is done in the registration, scheduling & billing database 50 to determine whether she is an existing patient.
If she is not an existing patient, she will also be asked for her SSN, sex, date of birth, phone number, the referring physician's name, and insurance details 52. The following additional information 54 will be requested:
   A copy of the patient's medical records,
   Pathology results and reports,
   Imaging results and reports,
   Preliminary diagnosis and cancer type (if applicable), and
   The name, telephone number, fax number and office address of the referring physician.
This information is keyed into 56 the registration, scheduling & billing system as preliminary registration information.
When a new patient is registered, a system interface will create a new patient record in the OIS 10 by populating key data elements.
The key data elements populated will be native to an OIS application.
Mary Jane is scheduled for first office visit. A nurse or front office employee prepares a new patient chart 58. This may involve contacting the referring physician's office to retrieve medical records. The following information is collected or verified during chart construction:
   Patient name,
   Home address,
   Home phone number,
   Work phone number when applicable,
   Name of referring physician,
   Insurance information,
   Insurance referral when applicable,
   Diagnosis,
   Medical records from referring physician,
   Pathology reports (ER, PR and Her-2/neu reports for breast cancer patients),
   Most recent lab work results,
   Radiology reports (CT Scans, X-rays, bone scans, MRI, etc.),
   Operative reports, and
   Discharge summary.
      Most of the above information is available in an EMR 60 and/or in paper format 62.
      A medical oncologist reviews the patient chart, patient history, radiology reports, pathology reports, etc. 64.
      The oncologist confirms Mary Jane's diagnosis with Stage II Breast Cancer 66.
      The oncologist discusses possible treatments and outcomes with the patient 68.
      The oncologist recommends chemotherapy followed by a course of radiation therapy 70.

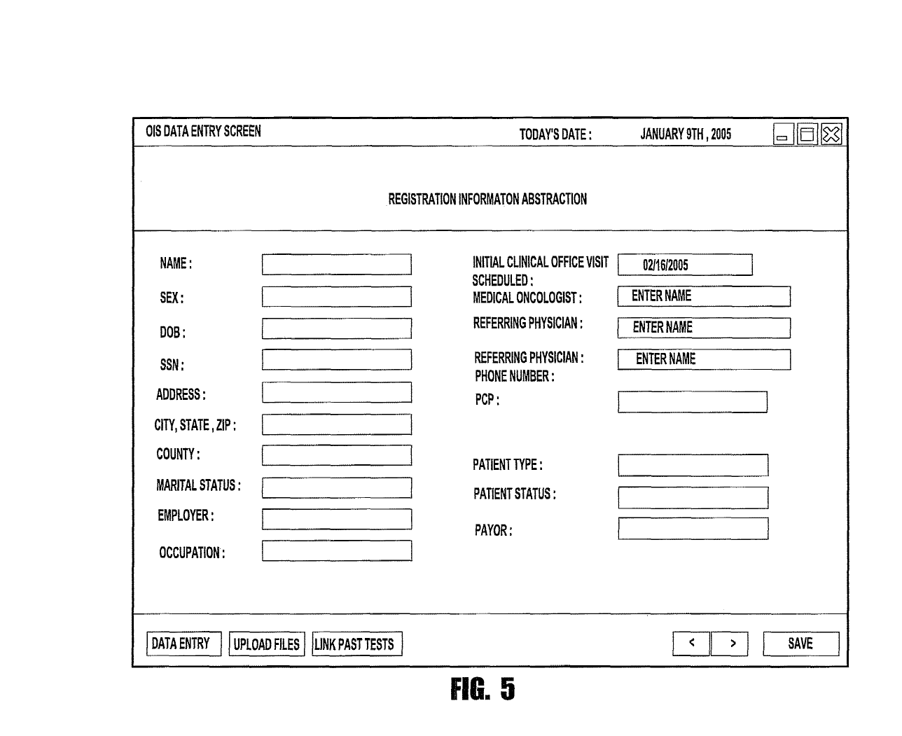

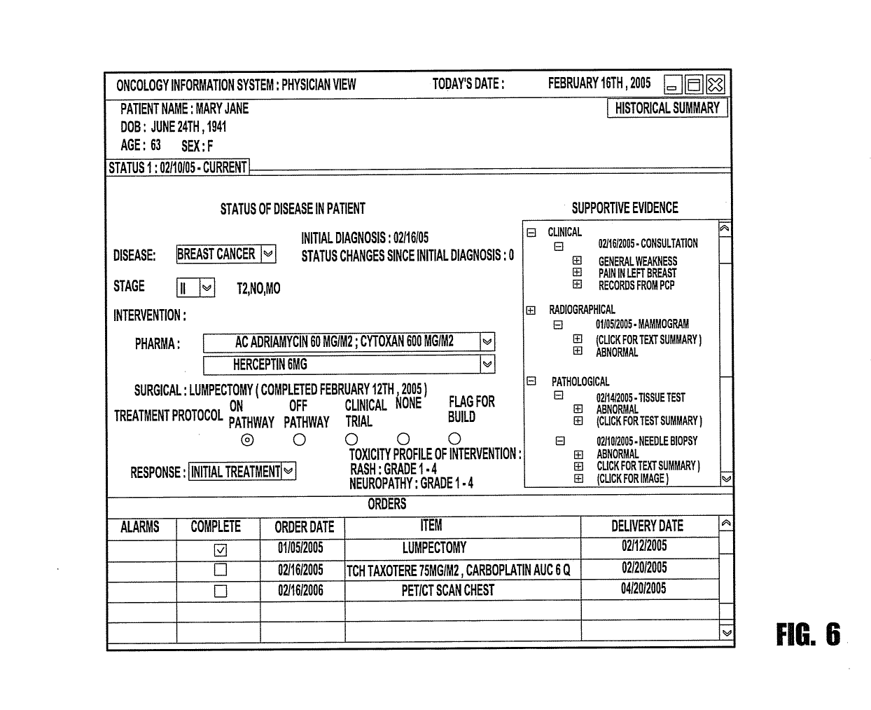

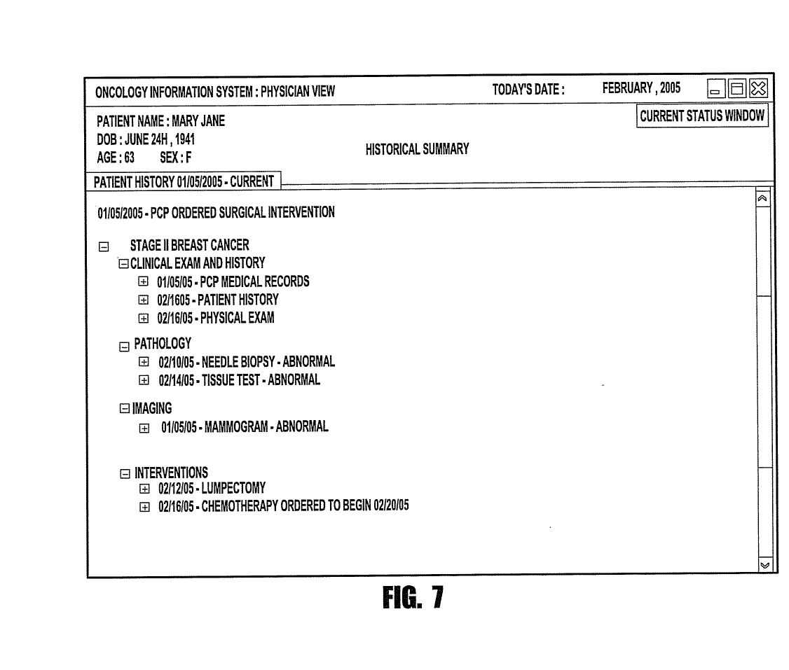

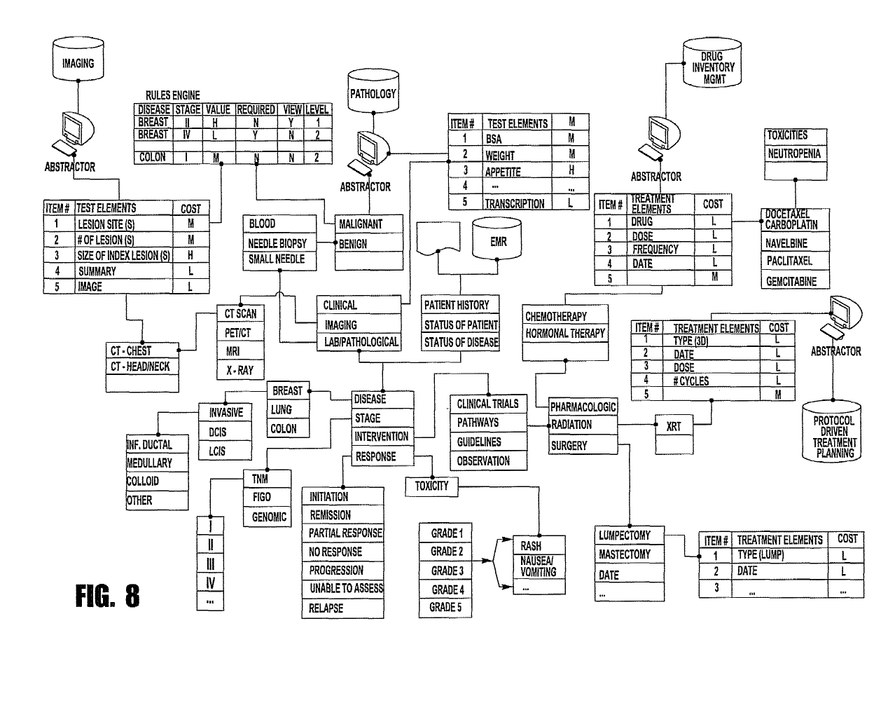

FIGS. 5, 6 and 7 are examples of screen displays that can be used for the entry and display of data associated with the registration and first office visit 18. In particular, FIG. 6 illustrates the presentation of supporting evidence as it relates to the health care provider's answers to the four questions: disease, stage, intervention and response. FIG. 8 is a diagram of a data model of an information system that can be constructed in accordance with an example of the clinical office visit. The data model of FIG. 8 illustrates the pieces of information that are accessed and hierarchically organized based on programmable disease/stage rules for a patient's initial registration and first office visit.

During the course of an examination, the physician and/or the clinical staff will ask questions, examine the patient, take and/or verify the patient history, palpate specific areas and document this information. The clinical information is divided into three different levels. The first level denotes if the information is clinical. The second level information denotes the type of clinical test, and the third level information provides the details of the test along with the date when the test was conducted. Level n is the actual test result itself, and may be in its native form from an external system. The information may be stored in a paper chart/EMR. History and physical examination information is abstracted and entered into the OIS.

Tumor size is the size of the (malignant) tumor and it is measured via various imaging modalities. The reports may be written by the radiologist and available for the physician through the imaging system. The treating physicians may re-measure the tumor size to be cautious with the results. This information may be critical in understanding the spread of cancer and also the decision that needs to be taken about the timing of surgery. Tumor size information can also come from pathology (e.g., following a lumpectomy). Such information is abstracted and stored in the OIS 10.

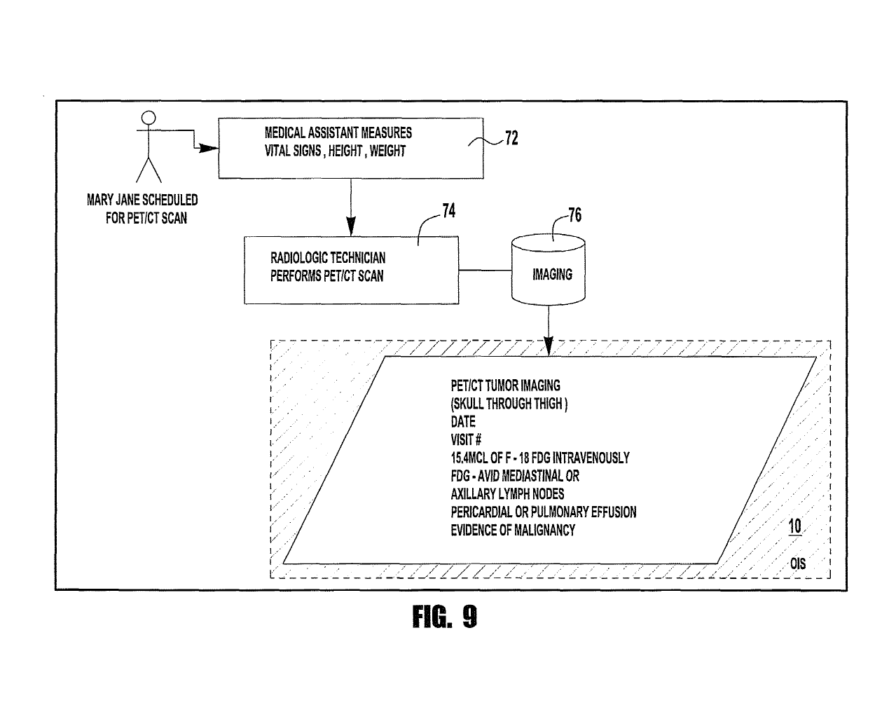

FIG. 9 is a sample diagram of a workflow process for an imaging event 20.

In this case, the pre-condition is:
Mary Jane is scheduled for PET/CT scan 70.

The process steps for this case are:
A medical assistant measures vital signs, height and weight 72.
A radiologic technician performs PET/CT scan. The image and summary are stored in an imaging system 76.
Relevant data elements are abstracted from images in the imaging system 76 and entered into the OIS 10.
Table 3 shows the data elements that are relevant to an imaging case 20

TABLE 3
OIS Data Elements

| | | | | | | Source | Create/Update/ |
|---|---|---|---|---|---|---|---|
| Data Field | Disease | Stage | Level | Cost | Value | System | Read-Only |
| Imaging Test Date | Breast Cancer | II | 2 | L | H | Imaging | Read-Only |
| Imaging Type | Breast Cancer | II | 2 | L | H | Imaging | Read-Only |
| Auxiliary Lymph | Breast Cancer | II | 2 | L | H | Imaging | Read-Only |
| Nodes | | | | | | | |
| Pulmonary Effusion | Breast Cancer | II | 3 | L | H | Imaging | Read-Only |
| Evidence of | Breast Cancer | II | 2 | L | H | Imaging | Read-Only |
| Malignancy | | | | | | | |
| Normal/Abnormal | Breast Cancer | II | 1 | L | H | Imaging | Read-Only |

Table 4 shows cost and value descriptions for low, medium and high designations that can be applied to the data elements of Table 3.

TABLE 4

| Legend | Cost | Value |
|---|---|---|
| Low (L) | Data is either known by user or already exists in a | Adds little value to the use of |
| | database with an existing standard interface | the OIS system |
| Medium (M) | Data exists in >1 systems and/or unique to | Adds ability to produce |
| | specialty; or is abstracted by low-cost resource | performance/other measures |
| High (H) | Data is only available in raw analog format and will | Required to answer one of the |
| | need to be abstracted by a licensed professional. | four questions or impacts |
| | Data is extremely large, etc. | revenue |

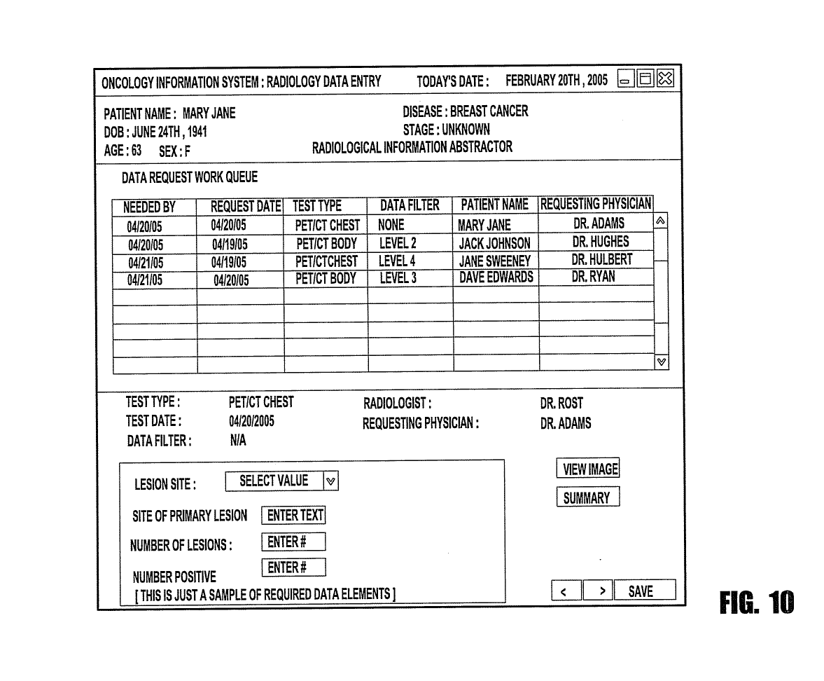

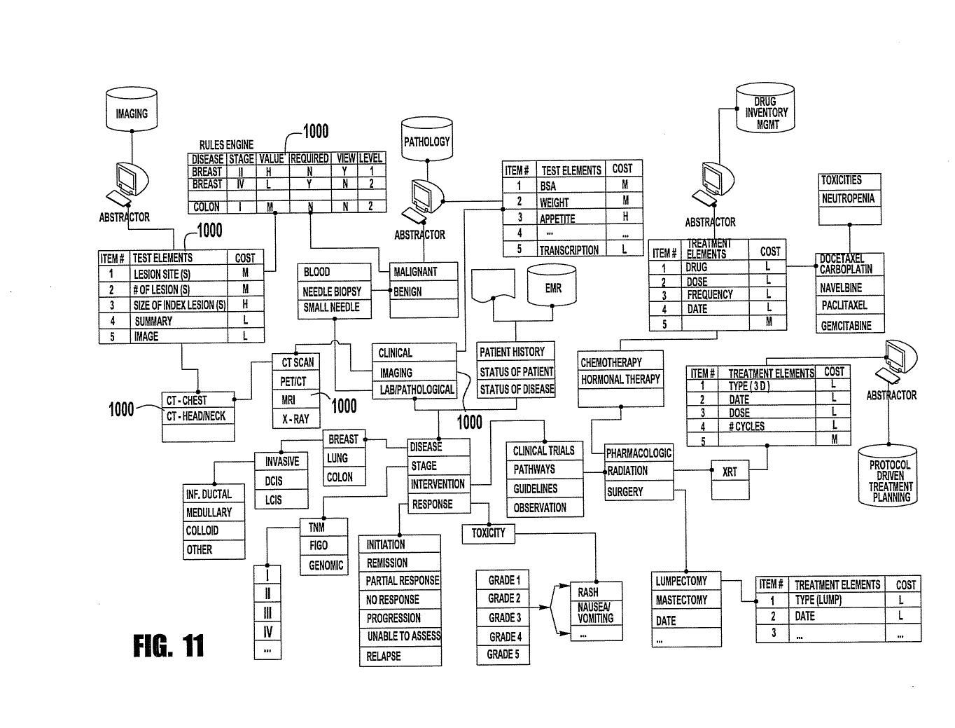

FIG. 10 is a radiological data entry screen. FIG. 11 is a diagram of a data model with elements relating to a radiological event indicated at 1000. The data model of FIG. 1 1 illustrates the pieces of information that are accessed and hierarchically organized based on programmable disease/stage rules for a radiology (imaging) event.

The physician recommends any of the most commonly ordered scans like PET/CT/MRI/X-Ray/mamogram or ultrasound based on examining the patient. The first level information is the type of study. Second level information is the type of imaging study. The third level information contains the number of lesions, the locations of lesions, the size of lesions and the date of study. The fourth level information will be the actual image. The user ID of the person that documents the imaging report is also captured in the third level. Most of the information may be stored on paper/film or in the imaging repository.

An imaging summary may be a short textual summary from any of the PET/CT/MRI/X-Ray/mammogram or ultrasound modalities along with the date the scan was performed. This information can be abstracted, structured and stored in the OIS 10 (e.g., when there is a significant change from the previous/comparison scan). A detailed version of the summary may be captured by the radiologist and entered in the imaging system. The treating physicians just need a summary comparing the current scan with the previous scan.

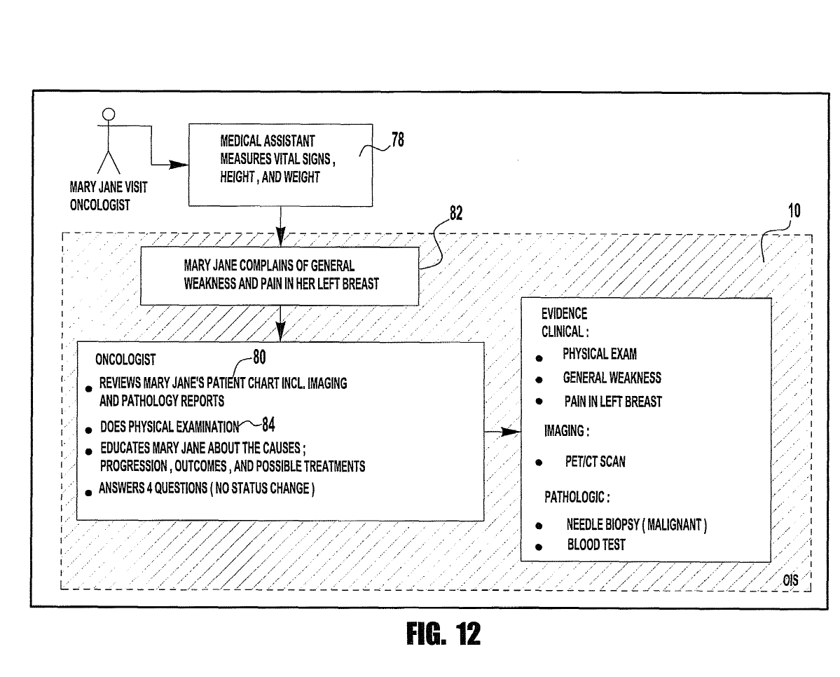

FIG. 12 is a flow diagram that illustrates a generic clinical office visit 22.

For this case, the pre-conditions are:
Mary Jane is diagnosed with Stage IIA Breast Cancer 66.
She is scheduled for a regular clinical office visit.

The process steps are:
The medical assistant measures vital signs, height, and weight 78.
The office staff prepares the patient chart.
The medical oncologist reviews Mary Jane's patient chart including the pathology and imaging tests 80.
Mary Jane complains of weakness and pain in her left breast 82.
The medical oncologist performs a physical exam and confirms no change in status 84.

Table 5 shows the data elements that are relevant to a clinical office visit 22.

TABLE 5
OIS Data Elements

| | | | | | | | Create/ |
|---|---|---|---|---|---|---|---|
| | | | | | | Source | Update/ |
| Data Field | Disease | Stage | Level | Cost | Value | System | Read-Only |
| Disease | Breast | II | 1 | L | H | OIS | Create or |
| | Cancer | | | | | | Update |
| Stage | Breast | II | 1 | L | H | OIS | Create or |
| | Cancer | | | | | | Update |
| Intervention | Breast | II | 1 | L | H | OIS | Create or |
| | Cancer | | | | | | Update |
| Exam Date | Breast | II | 1 | L | H | OIS | Create/ |
| | Cancer | | | | | | Read |
| | | | | | | | Only |
| Exam results | Breast | II | 1 | L | H | OIS | Create or |
| | Cancer | | | | | | Update |
| Response | Breast | II | 1 | L | H | OIS | Create or |
| | Cancer | | | | | | Update |

Table 6 shows cost and value descriptions for low, medium and high designations that can be applied to the data elements of Table 5.

TABLE 6

| Legend | Cost | Value |
|---|---|---|
| Low (L) | Data is either known by user or already exists in a | Adds little value to the use of |
| | database with an existing standard interface | the OIS system |
| Medium (M) | Data exists in >1 systems and/or unique to specialty | Adds ability to produce |
| | | performance/other measures |
| High (H) | Data is only available in raw analog format and will | Required to answer one of the |
| | need to be abstracted by a licensed professional. | four questions or impacts |
| | Data is extremely large, etc. | revenue |

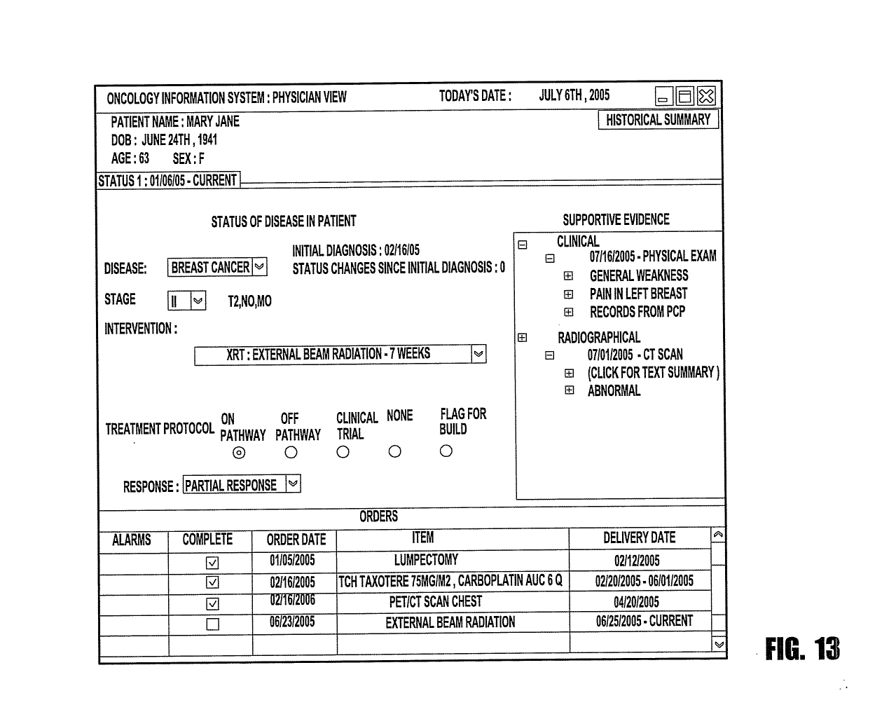

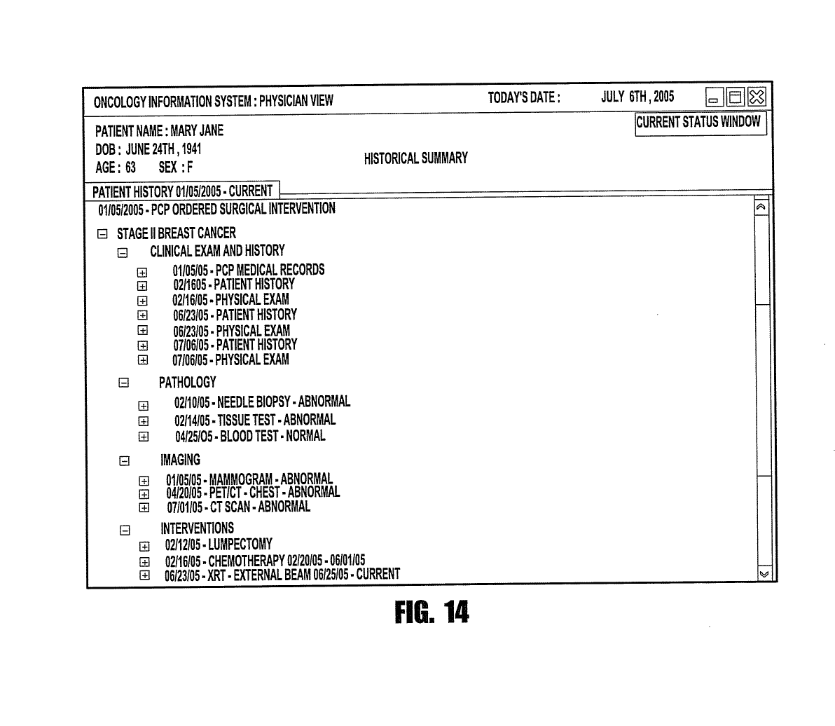

User interface examples for a generic clinical office visit 22 are shown in FIGS. 13 and 14. Based on the central notions of disease, stage, intervention and response, the user interface screens are built around the concept of the “Status of Disease and Status of Patient”.

FIG. 15 is a diagram of a data model with elements relating to a generic clinical office visit 22 indicated at 1100. The data model of FIG. 15 illustrates the pieces of information that are accessed and hierarchically organized based on programmable disease/stage rules for an office visit (physician consult).

The physician can record some of the key data items during the time of the office visit or a data coordinator can enter these items soon thereafter (e.g., the same day, to make everything is as close to “real-time” as possible).

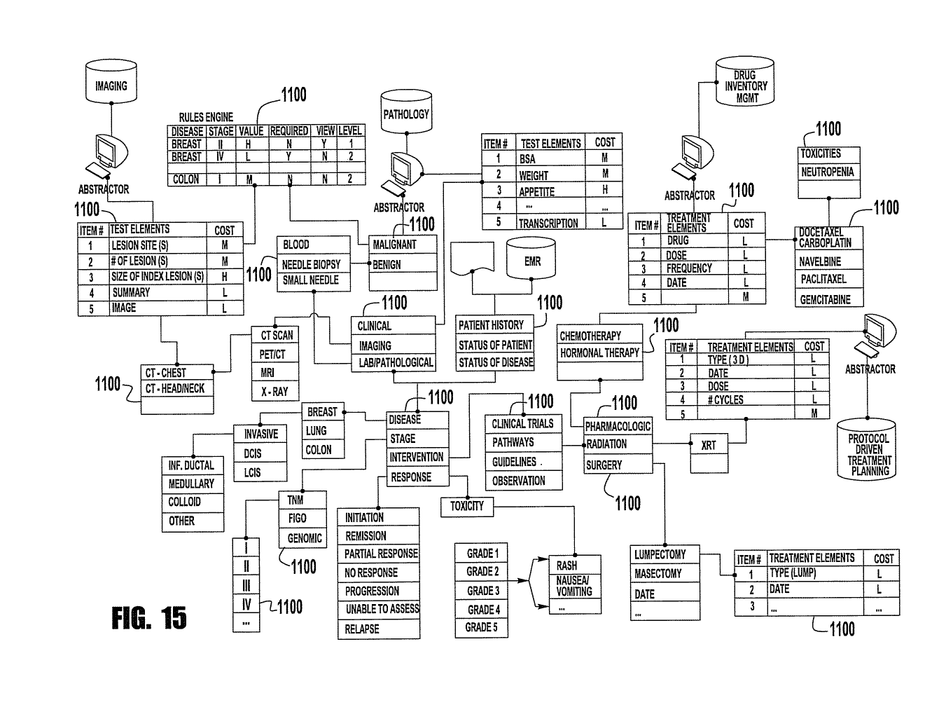

FIG. 16 is a diagram of the workflow process for a relapse event 24. In a relapse event, the pre-condition is:
Imaging and pathology test have been conducted and made available for the medical oncologist's review.

The process steps are:
A medical assistant measures vital signs, height, and weight 86.
The office staff prepares patient chart 88.
The medical oncologist reviews Mary Jane's patient chart including the pathology tests and imaging tests 90.
The medical oncologist talks to the patient and performs a physical exam 92.
The medical oncologist diagnoses Mary Jane with Stage IV Breast Cancer.
The medical oncologist discusses treatment options and recommends mastectomy followed by chemotherapy and hormonal therapy.
A treatment regimen is chosen 94.
The oncologist and nurse create orders relating to treatment plan.

Table 7 shows the data elements that are relevant to a relapse event 24.

TABLE 7
OIS Data Elements

| | | | | | | | Create/ |
|---|---|---|---|---|---|---|---|
| | | | | | | Source | Update/ |
| Data Field | Disease | Stage | Level | Cost | Value | System | Read-Only |
| Disease | Breast | IV | 1 | L | H | OIS | Create or |
| | Cancer | | | | | | Update |
| Stage | Breast | IV | 1 | L | H | OIS | Create or |
| | Cancer | | | | | | Update |
| Inter- | Breast | IV | 1 | L | H | OIS | Create or |
| vention | Cancer | | | | | | Update |
| Response | Breast | IV | 1 | L | H | OIS | Create or |
| | Cancer | | | | | | Update |
| Lesion | Breast | IV | 1 | L | H | Imaging | Read Only |
| Number | Cancer | | | | | | |
| Lesion | Breast | IV | 1 | L | H | Imaging | Read Only |
| Location | Cancer | | | | | | |
| Lesion | Breast | IV | 1 | L | H | Imaging | Read Only |
| Size | Cancer | | | | | | |
| Image | Breast | IV | 1 | L | H | Imaging | Read Only |
| | Cancer | | | | | | |
| Pathology | Breast | IV | 1 | L | H | Pathology | Read Only |
| Results | Cancer | | | | | | |
| Pathology | Breast | IV | 1 | L | H | Pathology | Create/ |
| Test | Cancer | | | | | | Read |
| Date | | | | | | | Only |
| Monocyte | Breast | IV | 2 | L | L | Pathology | Read Only |
| | Cancer | | | | | | |

Table 8 shows cost and value descriptions for low, medium and high designations that can be applied to the data elements of Table 7.

TABLE 8

| Legend | Cost | Value |
|---|---|---|
| Low (L) | Data is either known by user or already exists in a | Adds little value to the use of |
| | database with an existing standard interface | the OIS system |
| Medium (M) | Data exists in >1 systems and/or unique to specialty | Adds ability to produce |
| | | performance/other measures |
| High (H) | Data is only available in raw analog format and will | Required to answer one of the |
| | need to be abstracted by a licensed professional. | four questions or impacts |
| | Data is extremely large, etc. | revenue |

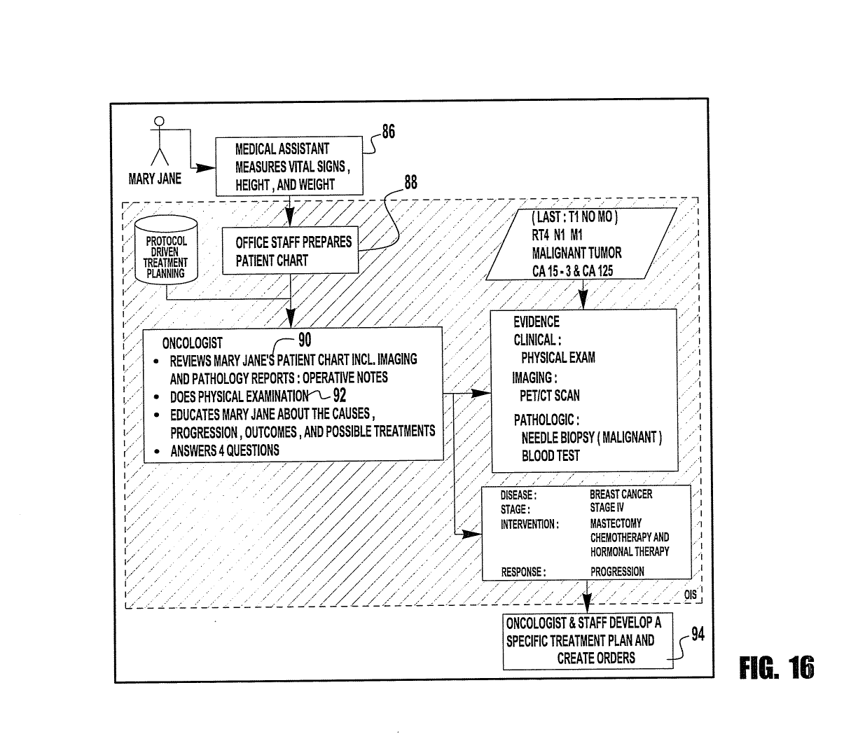

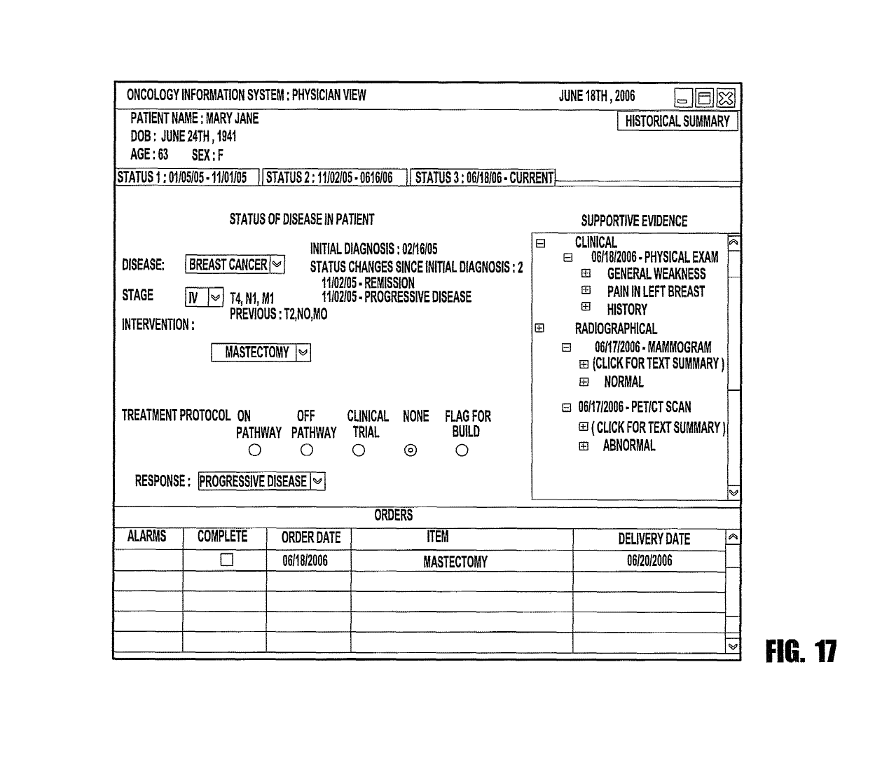

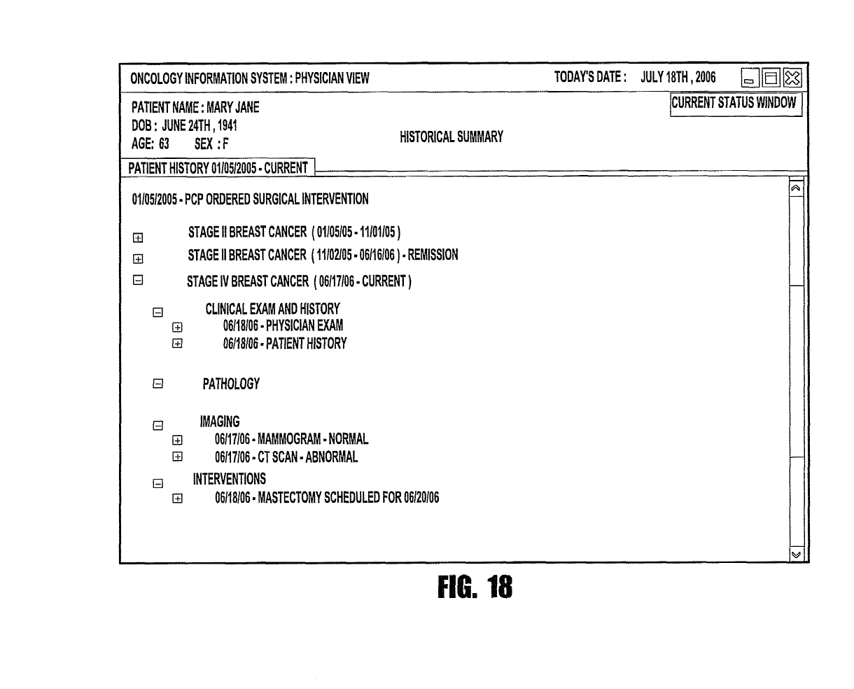

FIG. 17 is a disease status screen for a relapse event 24. FIG. 18 is a historical summary screen for a relapse event 24. FIG. 19 is a diagram of a data model with elements relating to a relapse event 24 indicated at 1200. The data model of FIG. 19 illustrates the pieces of information that are accessed and hierarchically organized based on programmable disease/stage rules for a relapse event.

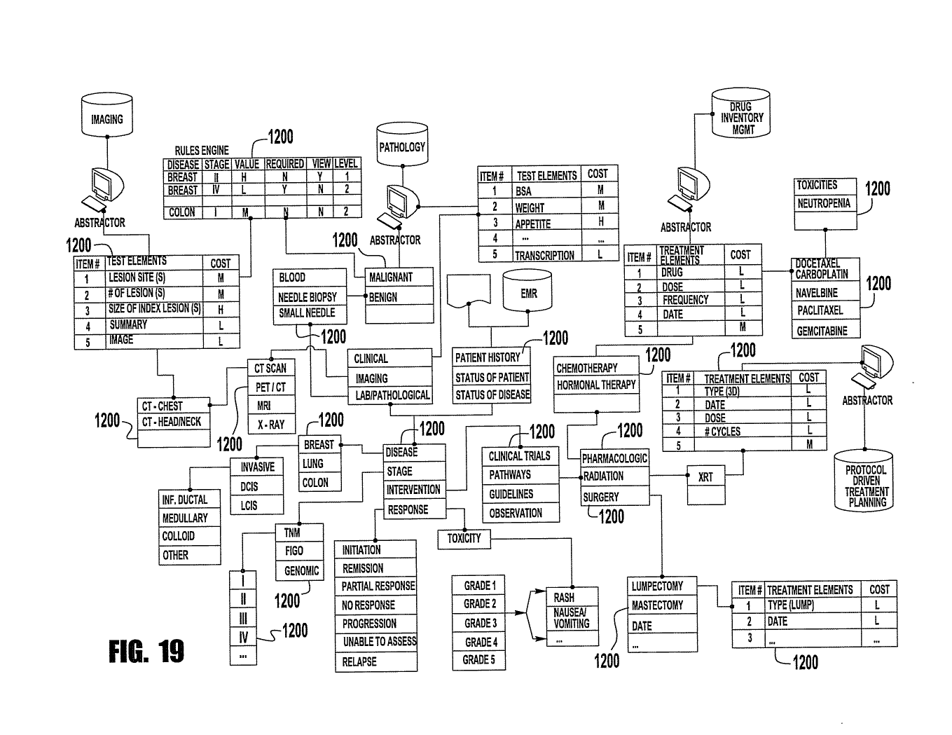

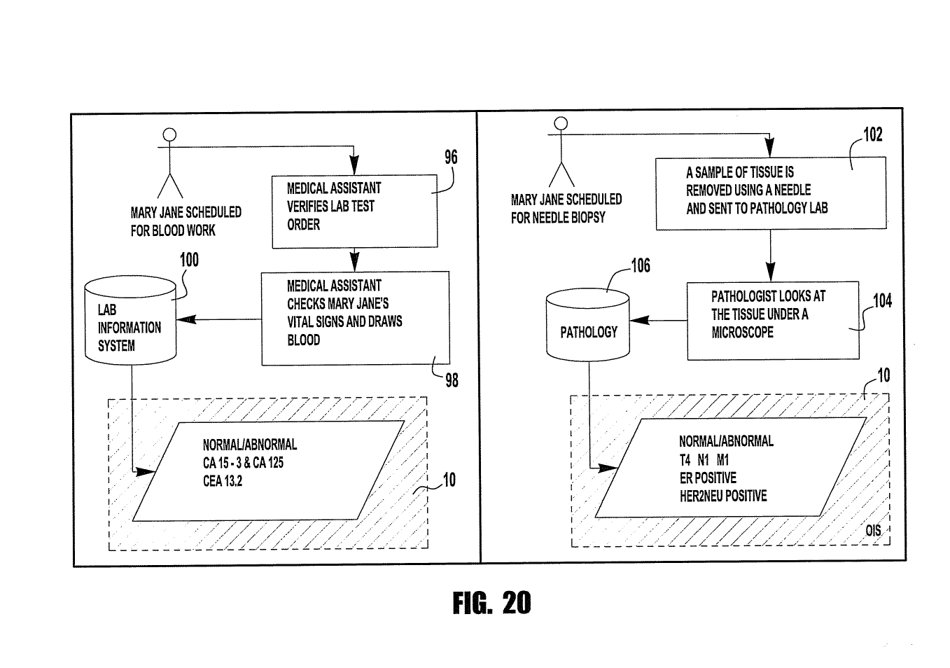

FIG. 20 is a diagram of a workflow process for a pathology event 26.

In a pathology event, the pre-condition is:
Mary Jane is scheduled for a needle biopsy.

The process steps are:

For a blood test:
A medical assistant verifies the lab order and measures vital signs, height and weight 96.
A lab technician reads the lab order and draws blood for analysis 98.
The blood test result data is recorded in lab information system 100.

For a needle biopsy:
The clinician removes a sample of tissue using a needle and sends to the lab 102.
A pathologist looks at the tissue sample under a microscope 104. After studying the tissue sample, the pathologist summarizes the findings in the tissue sample and prepares a pathology report.
The resulting data is recorded in a pathology system 106.
Relevant data elements from pathology system 106 are abstracted into the OIS 10.

Table 9 shows the data elements that are relevant to a pathology event 26.

TABLE 9
OIS Data Elements

| | | | | | | Source | Create/Update/ |
|---|---|---|---|---|---|---|---|
| Data Field | Disease | Stage | Level | Cost | Value | System | Read-Only |
| CA 15-3 & CA 125 | Breast | IV | 2 | L | H | Pathology | Create |
| | Cancer | | | | | | |
| Primary Tumor | Breast | IV | 1 | L | H | Pathology | Create |
| | Cancer | | | | | | |
| Regional Lymph | Breast | IV | 1 | L | H | Pathology | Create |
| Nodes | Cancer | | | | | | |
| Distant Metastasis | Breast | IV | 1 | L | H | Pathology | Create |
| | Cancer | | | | | | |
| Malignant | Breast | IV | 1 | L | M | Pathology | Create |
| | Cancer | | | | | | |
| Benign | Breast | IV | 2 | L | M | Pathology | Create |
| | Cancer | | | | | | |
| ER positive | Breast | IV | 1 | L | H | Pathology | Create |
| | Cancer | | | | | | |
| Her2Neu Positive | Breast | IV | 1 | L | H | Pathology | Create |
| | Cancer | | | | | | |
| Normal/Abnormal | Breast | IV | 1 | L | H | Pathology | Read-Only |
| | Cancer | | | | | | |
| Pathology Test | Breast | IV | 1 | L | H | Pathology | Read-Only |
| Date | Cancer | | | | | | |

Table 10 shows cost and value descriptions for low, medium and high designations that can be applied to the data elements of Table 9.

TABLE 10

| Legend | Cost | Value |
|---|---|---|
| Low (L) | Data is either known by user or already exists in | Adds little value to the use of |
| | a database with an existing standard interface | the OIS system |
| Medium (M) | Data exists in >1 systems and/or unique to | Adds ability to produce |
| | specialty | performance/other measures |
| High (H) | Data is only available in raw analog format and | Required to answer one of the |
| | will need to be abstracted by a licensed | four questions or impacts |
| | professional. Data is extremely large, etc. | revenue |

Pathology results that need to be captured include any of the pathological tests (relating to blood, serum, cell or tissue) that have significant values—or changes therein—that need the attention of the treating physicians. This information needs to be captured along with the date when the test was conducted. The information is available in the paper chart/EMR or pathology system. This information is entered and updated by the pathologist.

The pathologic tests that may be recommended by the physicians are CBC, LFT, CA Series, PSA, TH, T3, T4, BMP, CMP, RENAL, URIC ACID, PHOS, PT, MG, FOLATE, URINE, SPEP, IEP, Immunoglobulin, etc. The pathologic information is divided into several levels. For example, the first level may just denote if the information is normal or abnormal. The second level information may denote the type of pathological test, and the third level information may provide the details of the test results along with the date when the test was conducted. At the most detailed level, the actual test results in their native form are accessible. The information may be stored in a paper chart/EMR or pathology system. Key pathologic information is abstracted and entered into the OIS.

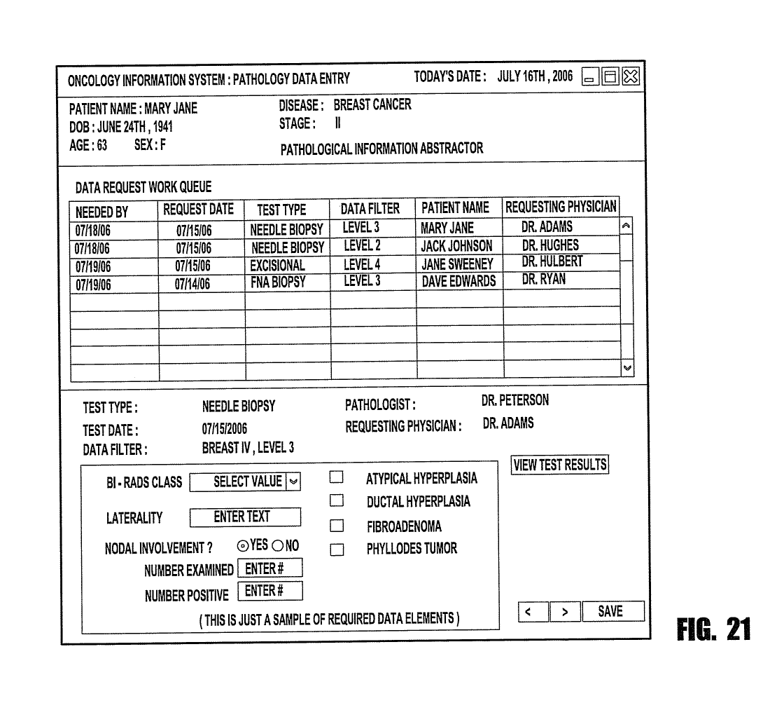

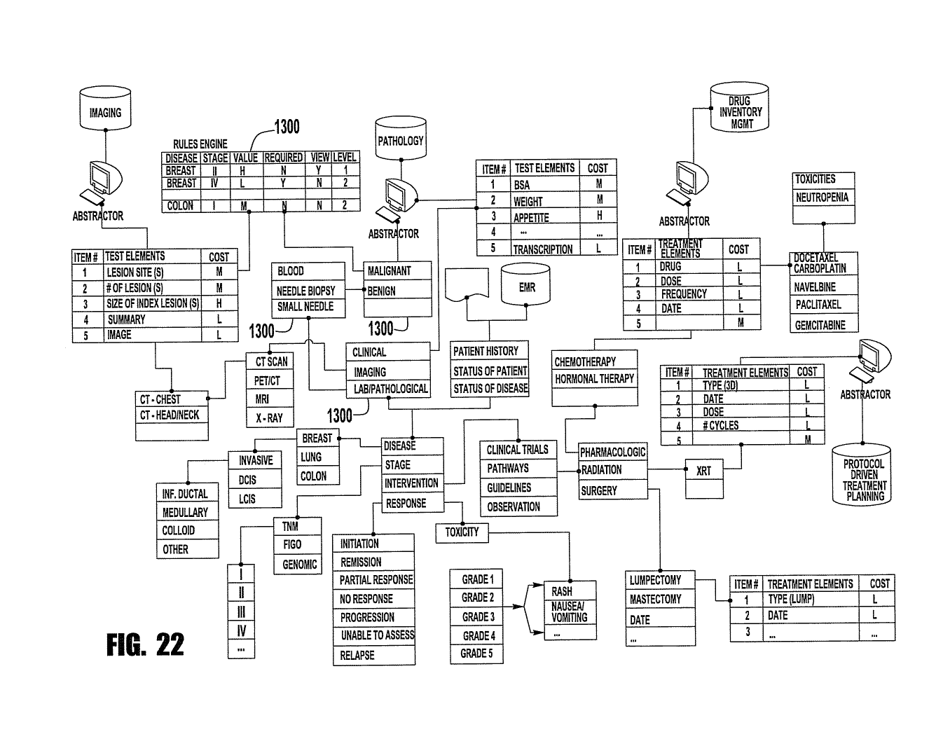

FIG. 21 is a pathology data entry screen. FIG. 22 is a diagram of a data model with the elements relating to a pathology event indicated at 1300. The data model of FIG. 22 illustrates the pieces of information that are accessed and hierarchically organized based on programmable disease/stage rules for a pathology event.

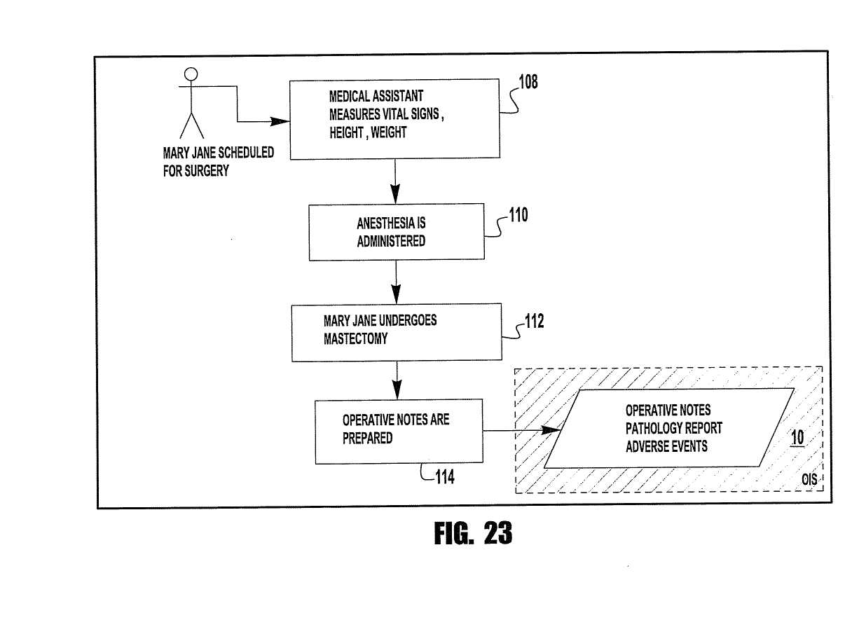

FIG. 23 is a diagram of workflow process for a surgical event 28.

In this case, the pre-condition is:
Mary Jane is diagnosed with Stage IV Breast Cancer. She is scheduled for surgery.

The process steps are:
The patient is prepped and vital signs are recorded 108.
Anesthesia is administered 110.
Mary Jane undergoes surgery and she is monitored during recovery for any adverse events (e.g., bleeding, infection) 112.
The oncologist prepares operative notes 114.

Relevant data elements are abstracted from pathology report and entered into the OIS 10.

Table 11 shows the data elements that are relevant to a surgical event 28.

TABLE 11
OIS Data Elements

| | | | | | | | Create/ |
|---|---|---|---|---|---|---|---|
| | | | | | | Source | Update/ |
| Data Field | Disease | Stage | Level | Cost | Value | System | Read-Only |
| Type of | Breast | IV | 1 | L | H | OIS | Read-Only |
| Surgery | Cancer | | | | | | |
| Date of | Breast | IV | 1 | L | H | OIS | Create/Read- |
| Surgery | Cancer | | | | | | Only |
| Tumor | Breast | IV | 1 | M | H | OIS | Read-Only |
| Size | Cancer | | | | | | |
| # of nodes | Breast | IV | 1 | M | H | OIS | Read-Only |
| removed | Cancer | | | | | | |
| Response | Breast | IV | 2 | M | H | OIS | Create/ |
| | Cancer | | | | | | Update |
| Normal/ | Breast | IV | 1 | L | H | OIS | Read-Only |
| Abnormal | Cancer | | | | | | |

Table 12 shows cost and value descriptions for low, medium and high designations that can be applied to the data elements of Table 11.

TABLE 12

| Legend | Cost | Value |
|---|---|---|
| Low (L) | Data is either known by user or already exists in a | Adds little value to the use of |
| | database with an existing standard interface | the OIS system |
| Medium (M) | Data exists in >1 systems and/or unique to | Adds ability to produce |
| | specialty | performance/other measures |
| High (H) | Data is only available in raw analog format and | Required to answer one of the |
| | will need to be abstracted by a licensed | four questions or impacts |
| | professional. Data is extremely large, etc. | revenue |

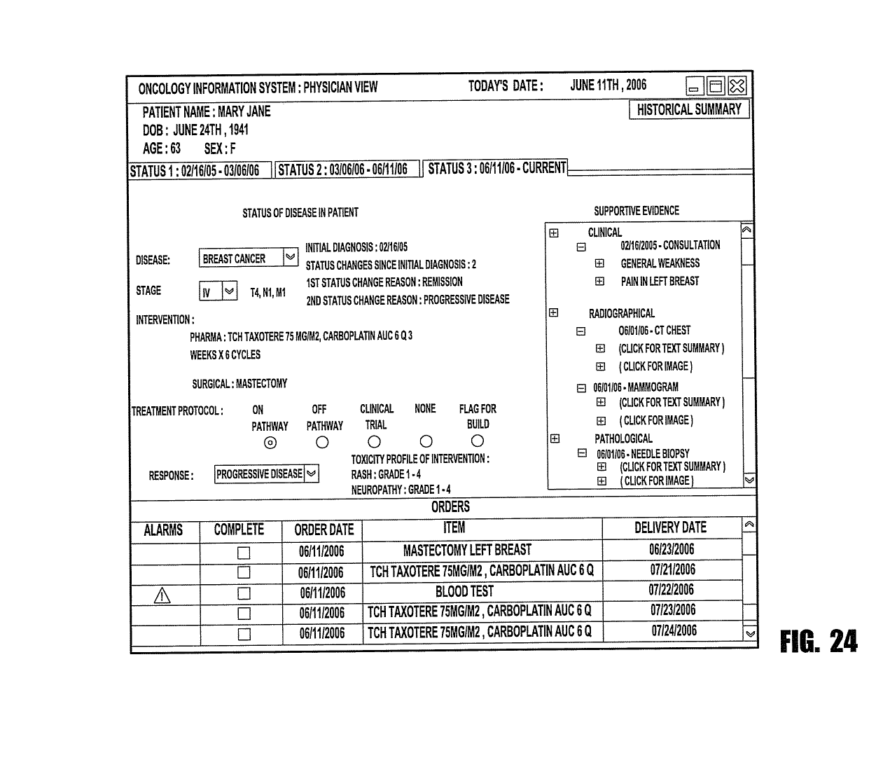

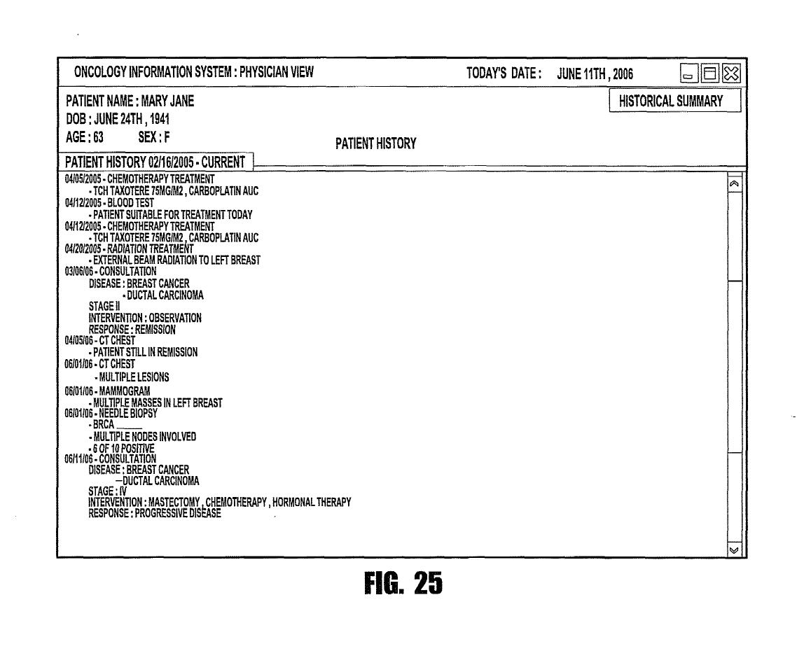

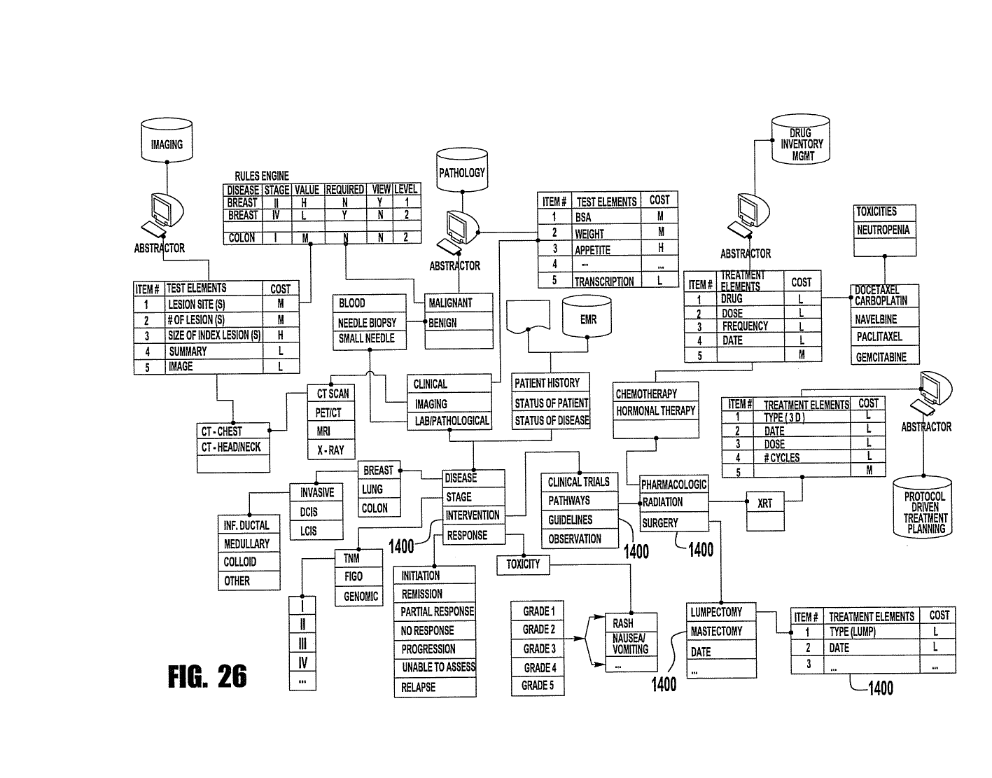

FIG. 24 is a disease status screen for a surgical event. FIG. 25 is a historical summary screen for a surgical event. FIG. 26 is a diagram of a data model with elements relevant to a surgical event indicated at 1400. The data model of FIG. 26 illustrates the pieces of information that are accessed and hierarchically organized based on programmable disease/stage rules for a surgical intervention.

FIG. 27 is a diagram of workflow process for a chemotherapy event 30.

In this case, the pre-condition is:
Mary Jane is diagnosed with Stage IV Breast Cancer.

The process steps are:
The medical assistant measures vital signs, height, and weight. Prior to starting chemotherapy treatment, a blood test is performed 116.
The nurse checks that Mary Jane's toxicity assessment is within guidelines 118.
The BSA calculation is done based on height and weight 118.
The BSA calculation determines the amount of medication to be prescribed 118.
A physician signs drug orders and the order sheet is sent to drug inventory management 120.
The following drug-related information is entered 121 into the system:
   TCH Taxotere 75 mg/m2 q
   3 weeks×4
   Carboplatin AUC 6 q
   3 weeks×6 cycles
The pharmacy technician mixes the chemotherapy medications and the infusion mixture is taken to the treatment room 122.
Each medication is checked independently by two nurses 124.
The nurse administers medication to Mary Jane 124.
Toxicity levels are recorded.
Relevant data elements are abstracted from drug inventory management and entered into the OIS 10.

Table 13 shows the data elements that are relevant to a chemotherapy event 30.

TABLE 13
OIS Data Elements

| | | | | | | | Create/ |
|---|---|---|---|---|---|---|---|
| | | | | | | Source | Update/ |
| Data Field | Disease | Stage | Level | Cost | Value | System | Read-Only |
| Date/Time | Breast | IV | 1 | L | H | Drug | Update |
| | Cancer | | | | | Inventory | |
| | | | | | | Mgmt. | |
| Drug | Breast | IV | 1 | L | H | Drug | Update |
| | Cancer | | | | | Inventory | |
| | | | | | | Mgmt. | |
| Dose | Breast | IV | 1 | L | H | Drug | Create |
| | Cancer | | | | | Inventory | |
| | | | | | | Mgmt. | |
| Frequency | Breast | IV | 3 | L | H | Drug | Update |
| | Cancer | | | | | Inventory | |
| | | | | | | Mgmt. | |
| Toxicity | Breast | IV | 1 | L | H | Drug | Create/ |
| | Cancer | | | | | Inventory | Update |
| | | | | | | Mgmt. | |
| Height | Breast | IV | 3 | L | H | Drug | Create/ |
| | Cancer | | | | | Inventory | Update |
| | | | | | | Mgmt. | |
| Weight | Breast | IV | 3 | L | H | Drug | Create/ |
| | Cancer | | | | | Inventory | Update |
| | | | | | | Mgmt. | |

Table 14 shows cost and value descriptions for low, medium and high designations that can be applied to the data elements of Table 13.

TABLE 14

| Legend | Cost | Value |
|---|---|---|
| Low (L) | Data is either known by user or already exists in a | Adds little value to the use of |
| | database with an existing standard interface | the OIS system |
| Medium (M) | Data exists in >1 systems and/or unique to | Adds ability to produce |
| | specialty | performance/other measures |
| High (H) | Data is only available in raw analog format and | Required to answer one of the |
| | will need to be abstracted by a licensed | four questions or impacts |
| | professional. Data is extremely large, etc. | revenue |

FIG. 28 is a diagram of a data model with elements relating to a chemotherapy event 30 indicated at 1500. The data model of FIG. 28 illustrates the pieces of information that are accessed and hierarchically organized based on programmable disease/stage rules for a chemotherapeutic intervention.

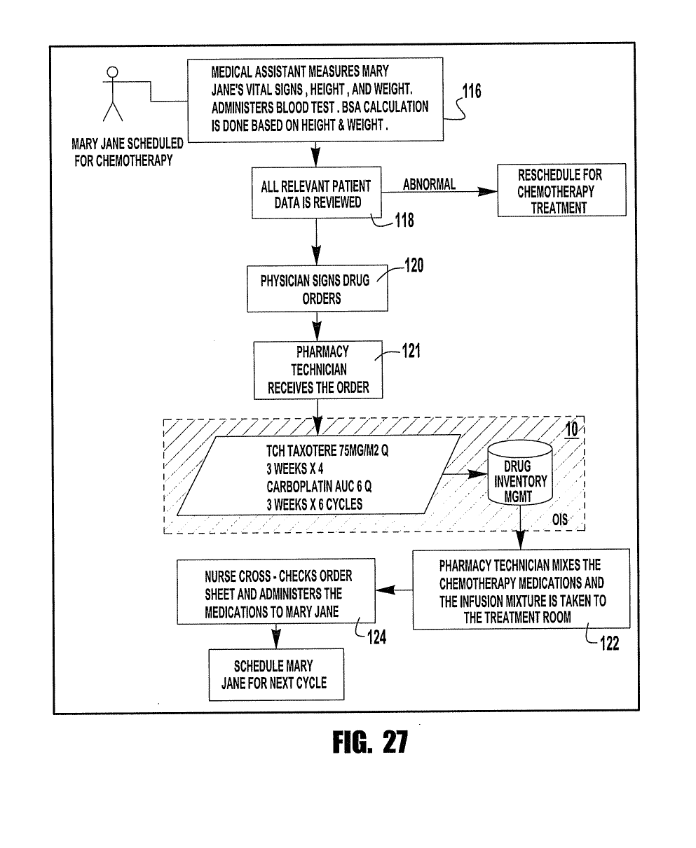

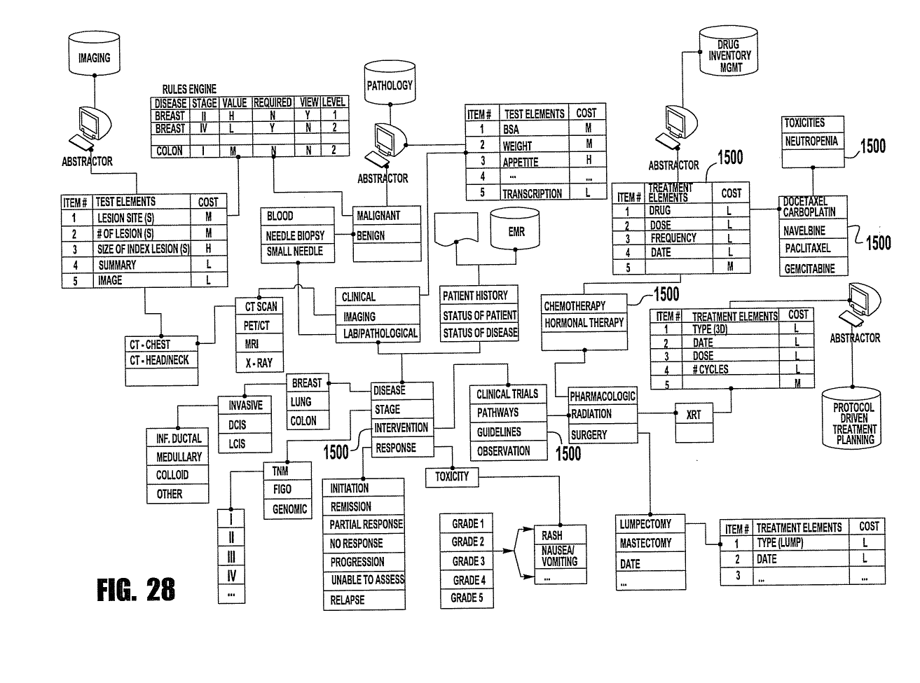

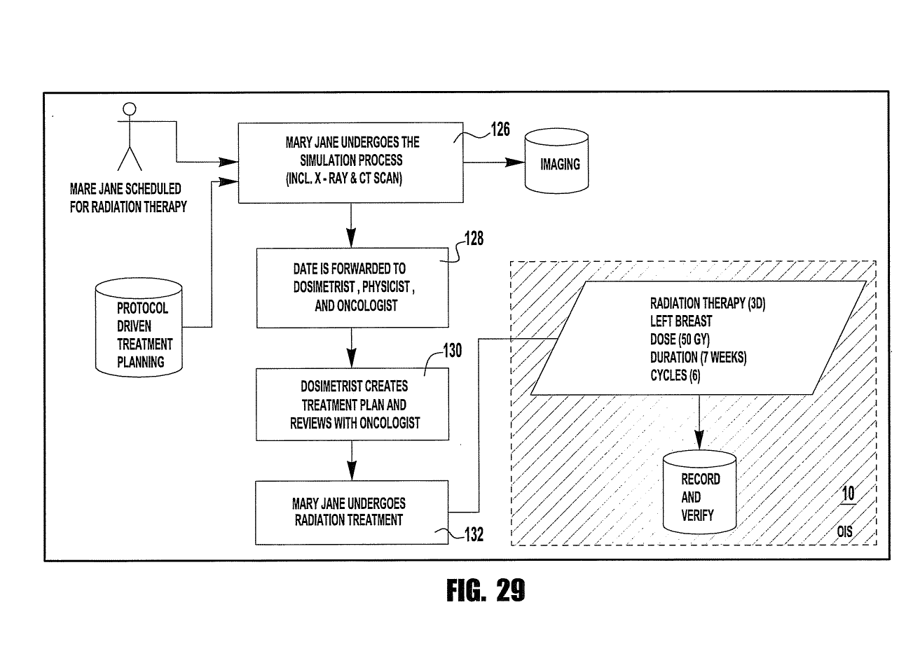

FIG. 29 is a diagram of a workflow process for a radiation therapy event 32.

In this case, the pre-condition is:
Mary Jane is diagnosed with Stage IV Breast Cancer.

The process steps are:
Mary Jane undergoes a simulation process relating to radiation planning 126.
The data is forwarded to dosimetrist, physicist, and oncologist 128.
The dosage is prescribed by the oncologist.
The dosimetrist creates treatment plan and reviews with radiation oncologist 130.
The radiation technician escorts the patient to a treatment room and administers the radiation 132 (e.g., lasting about 15 minutes).
Relevant data elements are abstracted from a record and verify system into the OIS 10.
Every 5th treatment day, the physician examines Mary Jane to check progress and answer any questions.
Mary Jane leaves after the treatment.

Toxicity may create a side effect or adverse event as a result of certain interventions. Most types of radiation and pharmacological intervention produce toxicity. There are various side effects of toxicity (e.g., nausea/vomiting, skin rash, neutropenia) that commonly affect the patient during the treatment. The intensity of the affecting toxicity is measured by a simple scale or grade with range from 0-4 (some of the newer guidelines call for using a 5-point scale generally corresponding to mild, moderate, severe, life threatening, and death). The toxicity may be measured by the nurse and entered in the paper chart/EMR or other task-specific systems. In the OIS 10, toxicity is part of the response measurement detail.

Table 15 shows the data elements that are relevant to a radiation therapy event 32.

TABLE 15
OIS Data Elements

| | | | | | | | Create/ |
|---|---|---|---|---|---|---|---|
| | | | | | | Source | Update/ |
| Data Field | Disease | Stage | Level | Cost | Value | System | Read-Only |
| Type of | Breast | IV | 1 | L | H | Imaging | Create |
| Radiation | Cancer | | | | | | or Update |
| XRT Date | Breast | IV | 1 | L | H | Imaging | Create |
| | Cancer | | | | | | |
| Dose | Breast | IV | 1 | L | H | Imaging | Create |
| | Cancer | | | | | | or Update |
| # Cycles | Breast | IV | 1 | L | H | Imaging | Create |
| | Cancer | | | | | | or Update |
| Duration | Breast | IV | 1 | L | H | Imaging | |
| | Cancer | | | | | | |

Table 16 shows cost and value descriptions for low, medium and high designations that can be applied to the data elements of Table 15.

TABLE 16

| Legend | Cost | Value |
|---|---|---|
| Low (L) | Data is either known by user or already exists in a | Adds little value to the use of |
| | database with an existing standard interface | the OIS system |
| Medium (M) | Data exists in >1 systems and/or unique to | Adds ability to produce |
| | specialty | performance/other measures |
| High (H) | Data is only available in raw analog format and | Required to answer one of the |
| | will need to be abstracted by a licensed | four questions or impacts |
| | professional. Data is extremely large, etc. | revenue |

FIG. 30 is a diagram of a data model with elements related to radiation therapy 32 indicated at 1600. The data model of FIG. 30 illustrates the pieces of information that are accessed and hierarchically organized based on programmable disease/stage rules for a radiation therapy intervention.

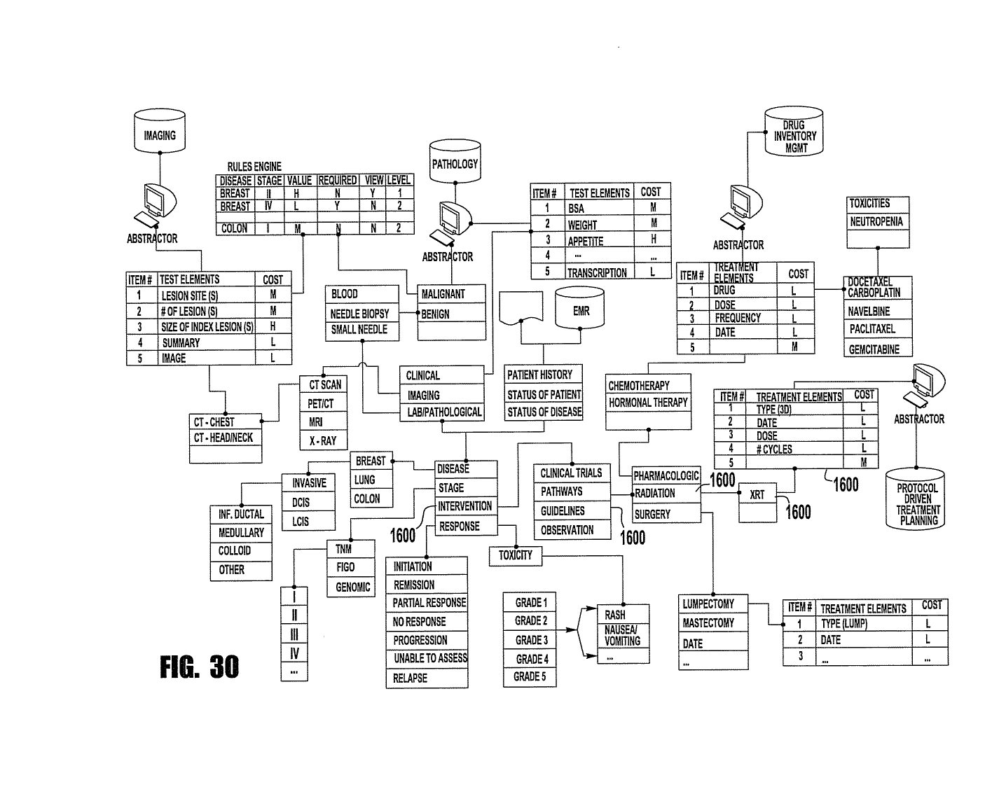

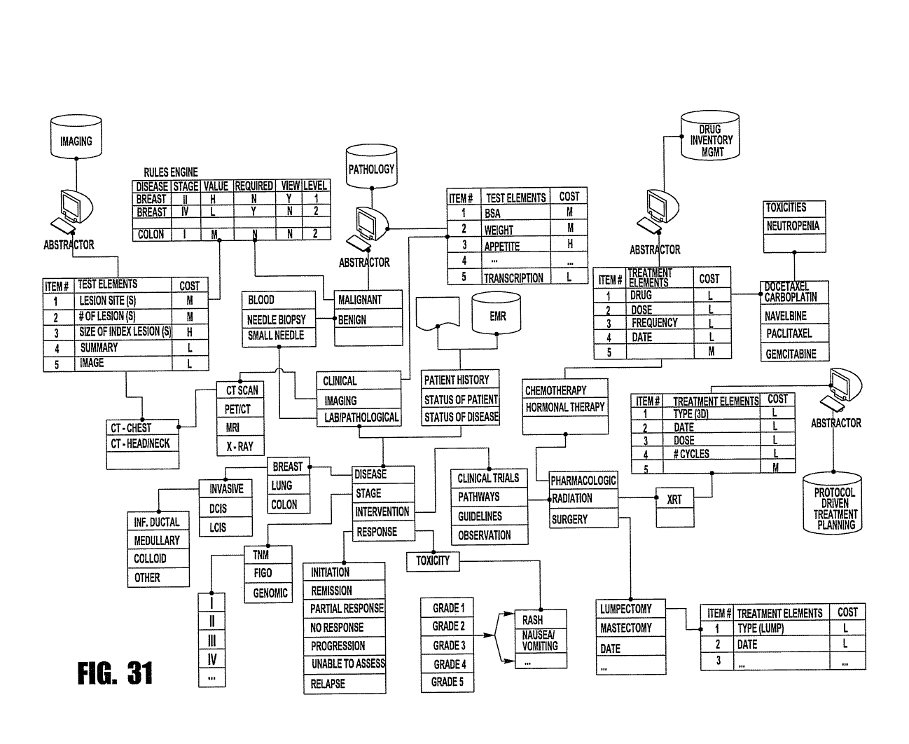

In various embodiments of the Oncology Information System 10, the disease type, staging of the disease, intervention type, and response to intervention are the four elements that are the root for all key data elements. The highest level of information is the four data elements, and the immediate supporting information for the four elements is the second level. The four elements and their immediate supporting information constitute the key data elements in the OIS 10. In previously known systems, not all information is collected at different phases of diagnosis and therapy, and not all collected information is stored in the database and accessed at various levels. In the OIS 10, the key data elements are entered and updated at all phases of a patient's treatment process. FIG. 31 is a diagram of a general data model.

To obtain this information, four questions are asked for each window. The same four repetitive questions serve to segment the timeline into meaningful intervals to which other databases become much more relevant (i.e., radiology, pathology, clinical trials, etc.). information for the required points on the primary timeline are generated every time there is clinical contact.

The four questions are:

1) What is the disease?

2) What is the stage of the disease?

3) What is the intervention?

4) What is the patent's response to the intervention?

For an example in which the disease is cancer, for the first contact and thereafter, the type of cancer (e.g., breast) is carried forward for verification.

The stage of the disease can be determined using standard staging criteria. Thereafter, the stage (status) is carried forward for verification or changed if there is supporting information (clinical/radiographic/pathologic).

In various embodiments, required points on the primary timeline are generated every time there is clinical contact. Once the disease is identified, the type of disease is carried forward for verification. The stage of disease can be determined using standard staging criteria. Thereafter, stage (status) is carried forward for verification or changed if there is supporting information (clinical/radiographic/pathologic).

For the initial stage and subsequent clinical visits, the clinician is asked “How is the stage (status) supported?” Information to support the designated stage comes from:
Clinical information (history and/or exam);
Radiographic information (any type of imaging); and/or
Pathologic information (blood or tissue tests).

The intervention(s) can be for example:
Pharmacologic;
Radiation therapy; and/or
Surgery.

Responses to the intervention can include for example:
Initiation (of intervention);
Remission;
Partial response;
No response;
Progression;
Unable to assess (how patient is responding; either too early or no information); or
Relapse.

For any intervention and determination of response to the intervention(s), the clinical team should provide details as to how the choice of intervention was determined, e.g., “remission” supported by:
Clinical information (history and/or exam),
Radiographic information (any type of imaging), and/or
Pathologic information (blood or tissue tests).

These are the same choices used to support the designation of disease stage (status).

Thus, embodiments of the medical information system described herein use the same set of four questions to clinically segment the timeline of the disease. This segmenting uses milestone type criteria which any cancer clinician/consultant/or internist would find important.

The boundary of points on the timeline are flexible, and determined by information deemed relevant to the clinical contact, for example assume the following events:
Aug. 12, 2006 CT scan,
Aug. 14, 2006 blood test,
Aug. 16, 2006 office visit,
Aug. 17, 2006 ultrasound,
Aug. 18, 2006 needle biopsy-pathology.

For the segment in the August 12-August 18 boundary, the clinical contact of Aug. 16, 2006 can be used to provide the answers to the four questions. In the example above, the boundary around the Aug. 16, 2006 clinical contact is determined by the dates of the pertinent tests within the clinical/radiographic/pathologic data sets.

Forcing the boundary development gives relevance to otherwise “floating” data sets in pathology, radiology, drug usage, supportive care, etc.

This process provides a meaningful core to which other modules can be interconnected. For example, billing for a drug would have an associated and important layer of information. That is, the drug was billed to treat a specific stage of cancer and yielded a particular response.

To be answered appropriately, the set of four repetitive questions asked at each clinical contact may require supporting data and an intervention. In addition, the intervention may require additional detail.

The level of detail provided can be made through a continued subsetting of structured data (“table data” is used herein to mean any structured data); for example, how a patient is doing in response to a pharmacologic intervention. As an illustration, assume that a patient has had CT radiographic study to assess response to the pharmacologic intervention. Table 17 shows several levels of detail relating to this intervention.

TABLE 17

| Level 1 | Level 2 | Level 3 | Level 4 |
|---|---|---|---|
| Radiographic | Type of study, e.g., CT | Results of CT Chest, e.g., | Measurements of |
| study | Chest. | nodules, pleural effusion. | abnormalities, |
| | Choices in a tabularized | Choices in a tabularized | e.g., size of a |
| | format would list the | format but customized for | nodule so it can |
| | universe of imaging | relevant information to | be quantitatively |
| | studies | that specific | compared to |
| | | cancer/stage/drug used. | prior/future CT |
| | | | studies. |

For example, the information in Level 1 is required and must designate clinical vs. radiology vs. pathology. The information in Level 2 may be required to delineate type of study. The information in Level 3 may be required, depending on the cost of information extraction or entry and clinical utility. This information in Level 4 may be required only if a patient is on a research study.

As the levels become higher, generally so does the cost of obtaining the information. A typical problem with clinical databases is a lack of flexibility, i.e., one size fits all and hence all fields are expected to be completed for all cases.

The hierarchal, digitized CT information regarding the response of the patient gives relevance to the CT scan—rather than just a scanned copy of the report electronically attached to the patient's ID number. Furthermore, embodiments of the system 10 provide the flexibility to allow the following:
A level may be required vs. optional (but might only require eventual completion).
A level must be filled out each visit or the patient cannot receive treatment. This allows for unique and powerful management tools. A simple example would be an expensive drug which can only be used in a particular stage of a cancer.

This format forces tableization (digitization) of reports usually only found in an analog format. In addition, the importance of report information content can be separated into tiers by having levels 1-n. Lastly, the system provides the ability (flexibility) to require a particular level of detail in reporting, e.g., level 1-3 (required) level 4-n (optional).

The fundamental clinical issues for a healthcare provider are: Patient's disease, stage/status of disease, intervention, and response to intervention. This is true of cancer, cardiac disease, pulmonary disease, etc. In a typical record (EMR or paper record) this information is obtained by extracting data from office notes, lab results, X-ray reports, etc. Even having the above information available still requires a clinician to synthesize the data into a relevant point along the clinical timeline. Frequently this is done in a summary paragraph in the office note. In a long complicated case, following this information from office notes, though critical, is often a quagmire. Other data points from administrative, financial and billing are not interconnected in any meaningful way. Insurance reimbursement for a drug may depend on whether it is approved for a particular cancer, a particular stage of that cancer, and sometimes, or even a subset that expresses a certain laboratory tested phenotype/genotype. There was previously no easy way for administrative/billing personnel to verify this. Furthermore, pay for performance will require an institution to have virtual real-time access to intervention and response to the various diseases.

Capped insurance contracts require knowing how much is spent in pharma/XRT/surgery to treat a particular stage of disease. Immediate identification of patients who are eligible for a clinical trial (i.e., having a particular disease/stage/treatment history) will increase accrual. All of the above are made possible and efficient by this database structure.

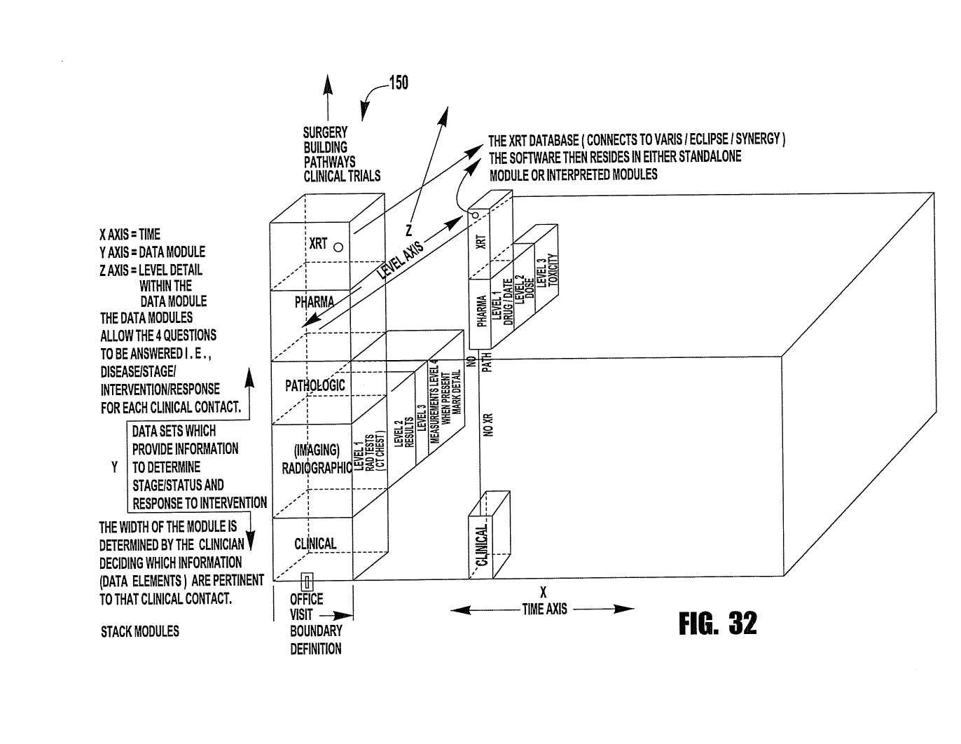

FIG. 32 is a schematic representation of an information system 150 constructed in accordance with an aspect of the invention. FIG. 32 shows a timeline representing a series of events that are organized into windows of the status of a disease in a patient.

The stage of the disease can be established in an initial office visit. The stage of the disease can change with each visit. Ends of the windows can be defined by confirmation of or change in status or an intervention.

The status of the disease in a patient includes an assessment (e.g., a stage of the disease), and an indication of the support for the assessment, for example, clinical, radiological, and/or pathologic data.

Several parameters can be used to assess the utility of each set of data or level of data. These parameters include: requirements (i.e., which fields are inviolate), source(s), costs, value (reporting), and example(s).

Types of interventions may include: observation only; neo-adjuvant (e.g., pharmacological, radiographic (pre-surgical), or both); adjuvant (radiation therapy (XRT), pharmacological, or surgical, including post neo-adjuvant, initial intervention (not neo-adjuvant), or pathologic information.

Types of responses may include: complete response, partial response, no response, progressive disease, or unable to assess (this response may be used until immediately pre-surgery).

For each response provided above (except unable to assess) an indication can be provided which states how the response is supported, e.g., using clinical, radiological, and/or pathologic data. Response of the patient to treatment can also be captured (e.g., rash, etc.) and may be monitored based upon co-morbidity, specific pharmacologic or clinical trial requirements, etc.

Several parameters can be used to assess the utility of each response, including: requirements (i.e., which fields are inviolate), source(s), costs, and value (reporting).

Costs and values can be assigned in accordance with oncology pathways. An appropriate pathway can be selected based upon the status of the disease in a patient, including the disease stage, intervention(s), and response(s) to intervention(s), as well as supporting information for these parameters.

Suggestion(s) and/or prescriptive interventions can be provided at the time of physician selection. New pathways can be constructed based upon actual intervention plans for a specific status of disease. Exception handling can be provided for the intake of patients from other care providers.

An example of “data flow” for status, intervention(s) and response(s) is described below. A timeline is used to track a series of events. Windows of clinical status of the disease in a patient can be created along the timeline.

A status of a disease can be assessed in an initial office visit. The status may change with each visit. Ends of the window can be defined by confirmation of or change in status or intervention. A window of information that may be considered part of a status, includes information captured based on a “duration from current” evaluation, for example:
May 7 CT,
May 14 Office Visit,
May 17 Biopsy,
May 24 Serology, and
May 25 PET Scan.

The status is input at a point in time (e.g., the May 14 Office Visit), but information that is ordered as part of that visit will be considered as input into the “status of the disease in the patient”. A time interval can be established to support the time of observation. This interval can stop based upon initiation of an intervention. That is, an intervention can serve as a “hard stop” for accumulating observation input for a specific status.

For a given visit, information associated with that visit (i.e., tests, results, etc., both prior to and following actual visit date), can be recorded. The following are examples of the type(s) of information that might be presented.

An initial assessment and/or relapse indication requires that information regarding how that was determined (i.e., supporting information) is captured. While assessment of patients is a common concept, previous approaches did not explicitly identify the supporting information that led to the assessment (e.g., stage, status).

Support for the stage/status assessment can generally be acquired through one or more of the following categories of activity: clinical, radiological or pathologic. For each category of support, the following areas may be of value in planning and prioritizing the information that should be acquired:
Requirements (i.e., which fields are inviolate),
Source(s),
Costs,
Value (Reporting), and/or
Example(s).

The first four (i.e., requirements, source(s), costs, and value (reporting)) establish a utility description for the category, focusing on the acquisition of those data which provide the most value and on doing so in the most cost effective way(s).

During the course of the examination, the physician and/or clinical staff asks questions, examines the patient, takes and/or verifies patient history, palpates specific areas, and documents this information.

In order to track the activities associated with the establishment of the status of disease in the patient, embodiments of the invention have the ability to “Flag Orders” occurring as part of a “status of disease” visit, e.g., blood work, bone scan. In addition, some type of reminder to follow up on these orders may be included. Also, embodiments are able to “lock out” intervention(s) until the evaluation events are complete, but also to allow an override to the lock outs by designated clinical or administrative personnel.

For example: a patient may have no visible signs and symptoms, but may complain of ‘back pain’, triggering an evaluation/diagnostic procedure (e.g., CT scan). Although this event occurs in the future, the results should be included in the assessment (status) associated with the visit and tied to that date.

Initial assessment of the requirements can come from data identified for abstraction from existing records for new patients, patients coining from outside the system, and input from physicians and clinicians regarding utility of the information. Information sources include patient self-reports, prior medical records, physical examination, and/or blood and lab tests performed within the office/clinic, and/or ordered from reference labs for evaluation.

The cost to obtain this clinical information can include fully loaded (overhead, fringes, etc.) costs of personnel time required to obtain the information. Blood and lab tests can include the costs of personnel, allocation of equipment and/or information technology costs, and consumable costs. Costs associated with reference labs can include any charges, an allocation of initial and on-going costs to set up interfaces, as well as personnel costs associated with acquiring and handling samples and any related activities.

Information regarding how staging and status information is supported provides value in a pharmacologic evaluation, Kaplan Meyer curve development with an additional level of detail/support (publications), or in evaluating the initial patient assessment once additional, supporting information is obtained.

Interventions can define the end of previous “window(s)” of care and establish a series of repeating sets of information regarding the status of the disease in the patient including confirmation of the intervention, assessment of the response, documentation of supporting information, and confirmation of (or change in) status.

Interventions may be suggested from a pathways module, if available, as the physician identifies a particular intervention type. Alternatively, information regarding intervention(s) taken for a particular set of status of disease in patient characteristics can be used to build additions to a pathways module.

As illustrated in FIG. 33, in one embodiment, the invention can be implemented as an oncology information system (OIS) 10. At each clinical contact, the OIS 10 performs a series of logic functions related to a health care provider answering four fundamental questions described above, i.e., disease, stage, intervention and response. The system 10 organizes and stores data into meaningful, clinically relevant, hierarchical data structures defined through a user programmable rules engine. An OIS Rules Engine (OISRE) 152 facilitates the identification and collection of relevant data from external systems that support answers to the questions disease, stage and response. It can also generate a selection of appropriate intervention and diagnostic options.

The health care provider can then select one or more of the intervention and diagnostic procedure options presented by the OIS 10. Then the system 10 can initiate the appropriate steps for ordering the selected intervention and/or procedure. In turn, the results (e.g., response, toxicity, and actual treatment administration) details are made available to the OIS 10 from external systems. These data elements serve as supporting evidence to answer the four fundamental questions by the health care provider during the next clinical contact.

The OIS Rules Engine 152 receives the results of the OIS Processing Logic. The OISRE 152 can include standard rules for care, as well as outcome studies, clinical studies/research, insurance requirements, administrative reporting, and decision support. The OISRE 152 can be used to check supporting evidence data elements against specified rules to identify requested and missing data elements. The missing data elements can be queued for data capture through an abstraction screen.

The OISRE 152 can send back the intervention and diagnostic choices for the selected disease, stage and patient details. The OISRE 152 can create a request XML/HL7 message string using the input data and using the format of a request message stored in respective tables. The OISRE 152 can also send requests to external systems 154 such as clinical trials systems, radiology, pathology, EMR, pathways systems, guidelines systems, etc., and can pass responses to those requests back to the OIS 10 to present data for the health care provider to view. The health care provider can then take further action based on the data.

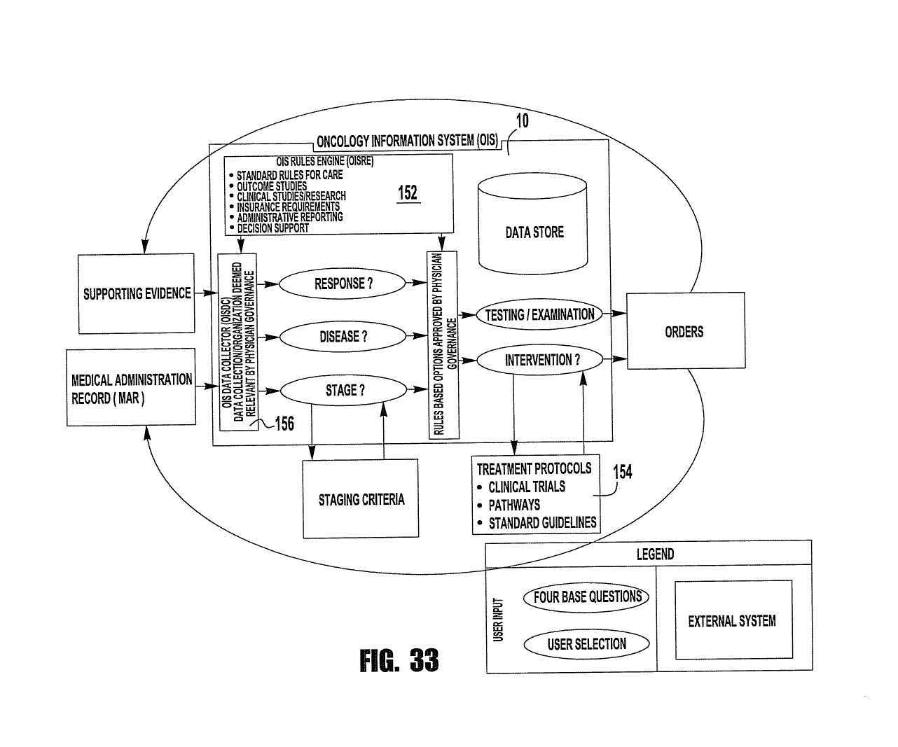

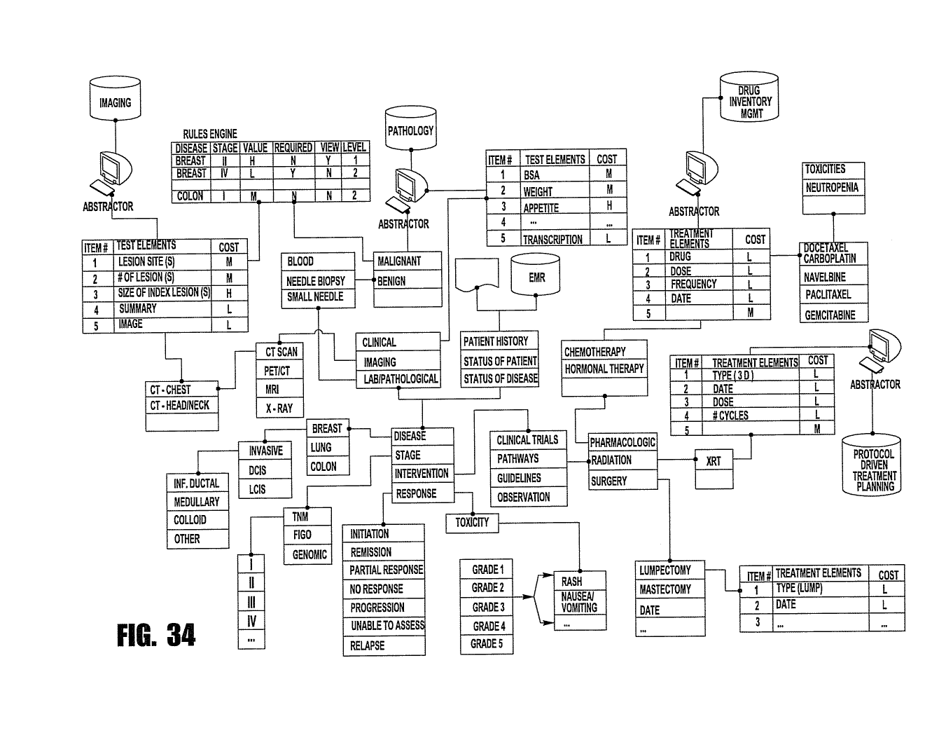

An OIS Data Manager (OISDM) 156 can organize, link, and store various data elements within the OIS database by their clinical relevance. Clinically relevant data can be identified by connecting required data elements specified in user defined rules with clinical results provided by external systems such as EMR, Radiology, and Pathology etc. The hierarchical organization of the data can be accomplished through rules defined in the OISRE 152. Meaningful data for the physician view and reporting purposes can be identified and derived from the data elements specified in the user configured rules. The approach to this data model is shown in FIGS. 33 and 34.

FIG. 35 illustrates a flowchart of a method performed according to various embodiments of the present invention. As illustrated in FIG. 35, a new patient 200 enters the system and registration information is captured at 202, including patient contact information, demographics, insurance information, etc. The patient's visits are scheduled at 204. Registration and scheduling data from 202 and 204 are sent to an embodiment of the system described herein, where a new record is created for the patient.

Returning patients 206 enter the system and are scheduled at 204. The scheduling data is then sent to an embodiment of the system described herein. Any hard-copy diagnostic reports 208 that are received for the patient from diagnostic testing services 210 or patient referrals are scanned into the system at 212. Electronic copies of reports 214, with or without structured data elements, are sent to the application from the diagnostic testing services 210. Once in the system, relevant discrete data elements are abstracted from the scanned images or electronic reports at 216.

In the system, a health care provider can search for the patient, or see the patient on their schedule, and can choose to open the patient record at 218. For a new patient 200, the answer to “Interventions Selected?” at 220 is “No”, and the answer to “First Status Window?” at 222 is “Yes”, so the health care provider enters the relevant patient history at 224. For returning patients 206, if no interventions have been selected yet in the current status window (the answer at 220 is “No”), and they are still in their first status window (the answer to 222 is “Yes”), the health care provider enters the relevant patient history in 224.

Once the patient history is recorded for patients in their first status window, the health care provider begins recording the parameters for the initial disease and stage baseline for the patient at 226. For returning patients 206, if no interventions have been selected yet in the current status window (the answer to 220 is “No”), but they are not in their first status window (the answer to 222 is “No”), the health care provider begins recording the parameters for disease and status for the current status window's baseline at 226.

For each question that the health care provider answers at 228, they will have reviewed the available diagnostic reports 230, and linked the appropriate diagnostic report(s) 230 to the answer as supporting evidence 232. The current clinical contact with the patient is also available as supporting evidence for a question if the health care provider made the determination based upon clinical examination or observation.

If the health care provider finishes answering disease and stage/status questions for that visit, but has not yet completed all of the required questions to establish the baseline (the answer to 234 is “No”), the health care provider has the opportunity to order additional diagnostic tests at 236 to provide them with more data in subsequent visits. The list of diagnostic tests presented to the health care provider can be prioritized according to those tests that have been identified as being relevant and recommended according to the rules defined in the system for the patient's current conditions. Once these diagnostics have been ordered and the relevant data has been sent to the diagnostic testing services 210, the visit ends at 238 and the relevant data is sent to billing at 240.

If the health care provider completes the disease and stage/status baseline questions during the visit (the answer to 234 is “Yes”), they select interventions for the patient from a filtered, prioritized list at 239. Rules are defined for each intervention in the system to guide the health care provider in selecting interventions using any of the data recorded for the patient. These rules can result in interventions being filtered from the list altogether, or being flagged with a warning to the health care provider. Once the interventions have been ordered and the relevant data has been sent to the treatment ordering/processing/administration systems 242, the visit ends at 238 and the relevant data are sent to billing 240.

As the treatment is administered between health care provider clinical contacts, relevant treatment administration records 242 are sent to update the intervention status in 244.

For returning patients 206, if interventions have already been selected in the current status window (the answer to 220 is “Yes”), the health care provider records the patient status and responses to treatments at 246. For each question 246 that the health care provider answers 228, they will have reviewed the available diagnostic reports 230, and linked the appropriate diagnostic report(s) to the answer as supporting evidence 232. The current clinical contact with the patient is also available as supporting evidence for a question if the health care provider made the determination based upon clinical examination or observation.

Once the status and responses have been recorded, the health care provider reviews the current interventions and makes any necessary updates or adjustments at 244. Any updates or adjustments that are made are sent back to the treatment ordering/processing/administration system 242.

After the current interventions are reviewed and updated, if the health care provider determines that a new treatment strategy is needed (the answer to 248 is “Yes”), the health care provider discontinues all current interventions in the system at 250, the system creates a new status window for the timeline at 252 and the health care provider begins recording the parameters for disease and status for the new status window's baseline at 226. The process continues as described above from 226.

After the current interventions are reviewed and updated, if the health care provider determines that the current treatment strategy is satisfactory (the answer to 248 is “No”), the visit ends at 238 and the relevant data is sent to billing 240.

FIG. 36 illustrates a data model that can be used in conjunction with the embodiments of the systems and methods described herein. Patient 400 refers to patient registration events and to the collection of patient demographics data including name, identification numbers, date of birth, gender, insurance information, and any other relevant information obtained from the patient at the time that a patient is added to the system. Clinical contact 402 refers to any interaction with the patient 400 during which questions about the diagnosis of disease, stage, recommended intervention, or response to an intervention can be answered, or any interaction during which any of these may change. The clinical contact 402 may be an initial visit, visit while on treatment, follow-up visit, problem-focused visit with a physician, etc. A patient 400 will have zero, one, or many clinical contacts 402.

Status windows 404 are determined by points in time where there is a significant change in response, disease, and/or stage. The status windows 404 can span multiple contiguous clinical contacts, with endpoints defined by a significant change in disease or patient status. Rules for status window endpoints can be specified in the programmable rules engine. Disease 406 represents the patient's 400 primary diagnosis. A patient 400 may have more than one primary diagnosis.

Stage 408 further describes characteristics of the disease diagnosis. Stage 408 may be based on industry-standard classifications. The health care provider diagnoses a stage 408 for every disease 406 diagnosis. Intervention 410 represents a health care provider's decision on treatment or therapy based on the patient's 400 disease 406 and stage 408. Response 412 represents the outcome or effect of an intervention(s) 410 on the disease 406 and refers to any toxicities and adverse events experienced by the patient 400 that are related to the intervention 410. Response 412 is viewed in the context of current status related to one or more interventions 410 and in the context of improvement or progression of disease 406 relative to status at a prior assessment.

Supporting evidence 414 refers to clinical, radiographic, and pathologic test results that the health care provider can use to diagnose disease 406, stage 408, or response 412. By linking test results that are deemed relevant by the health care provider to the diagnosis questions, the test results can be viewed as evidence that supports the diagnosis. Each diagnosis of disease 406, stage 408, and response 412 can be linked to one or many test results.

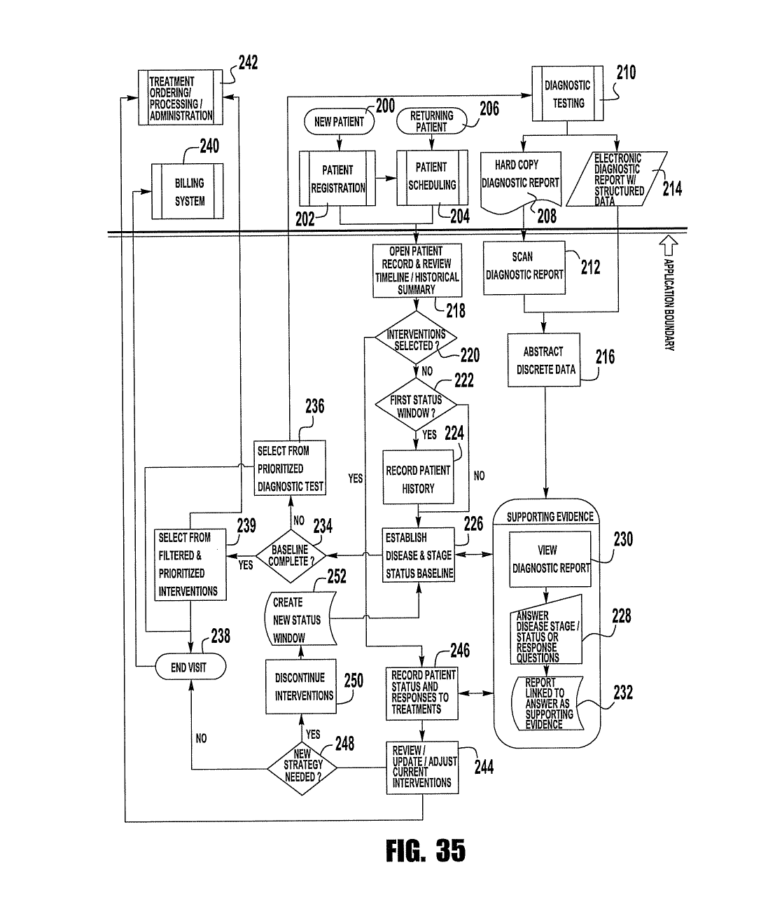

FIG. 37 illustrates a flow of data through the system described herein according to various embodiments of the present invention. FIG. 37 shows the types of data stored in the system 10 data store 420 and the flow of different inputs and outputs to and from the data store 420.

Data managed by ancillary services and systems, including patient registration 422 and patient scheduling 424, radiographic and pathologic diagnostic testing 426, and intervention administration records 428, when relevant, are entered to the system data store 420 either through manual abstraction 430, or electronically, depending on facility capability. Data in the system data store 420 can be provided for use by external systems or processes for intervention ordering 428 and billing 432.

The results of diagnostic testing 426 are provided to a health care provider either on a hard copy paper report 434 or electronically as a report or electronically as discrete structured data elements 436. If a paper copy of the diagnostic report 434 is provided, the report can be scanned 438 and displayed in the system 440. Manual abstraction functionality 430 saves test results as discrete data elements in the system data store 420. If an analog report of test results is transmitted electronically by the ancillary service, the report can be displayed 440 and manual abstraction 430 can be used to save as discrete data elements. If test results are electronically transmitted to the system as discrete data elements 436, data is stored directly to the system data store 420.

At a clinical contact with a patient, a health care provider has access to the patient record and to a historical summary and timeline of the patient's disease, stage, interventions, response, and related supporting evidence 442. When the health care provider answers the questions of disease, stage, and response 444 and specifies which test results were used as supporting evidence for each answer 446, the answers and links are saved in the system data store 420 and are recorded to the patient's history 448. Following review and patient exam, the health care provider can select a new intervention from a filtered and prioritized list of interventions 450, update or adjust current interventions 452, or discontinue interventions 454. The health care provider can also select from a list of prioritized diagnostic tests that are appropriate for the patient's disease and stage, or that are appropriate for the patient's current interventions or phase of treatment 456. A programmable rules engine automatically manages status window endpoints, based on health care provider answers and status window transition rules 458.

Data from the system data store 420 provides for reporting, extraction, or transmission of reports designed to make improvements in standards of patient care and business operations 460 and costs 462. Data can be provided for insurance reimbursement 464, for medical research publication 466, and for outcome studies of individual interventions 468. The data, reports, and analytics generate a feedback loop that allows updates to rules and guidance 470 leading to continued improvements in diagnosis, treatments, testing, and business practices.

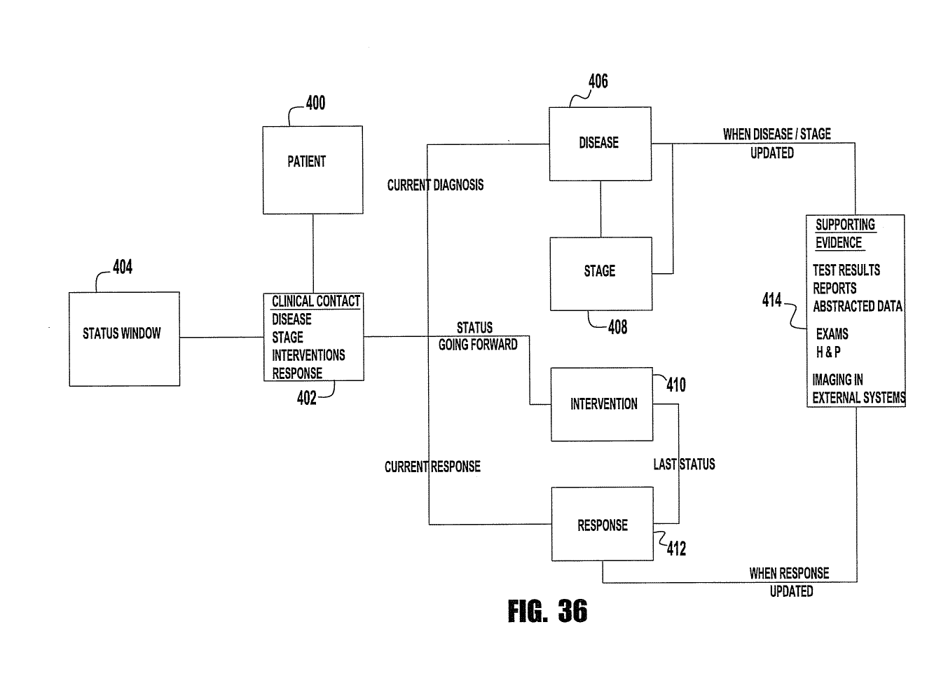

FIG. 38 illustrates a system diagram according to various embodiments of the present invention. FIG. 38 represents a conceptual overview of a “top-down” approach with the interaction the system described herein has with its users (e.g., physicians, business administration personnel, etc.) and external entities. External entities provide requirements such as costs, reimbursements, public domain medical information, treatment efficacy, etc. which may be used by the business as the basis for decision-making guidance enforced by the system. In return, the end user clinicians, being guided by the system, apply their knowledge and expertise to follow or disagree with the guidance, track disease and patient response and therefore contribute to an enhanced knowledge base the business can use to further refine its decision-making guidance in the system. Additionally, this knowledge base can be shared with external entities to leverage contractual arrangements, benefit public domain medical information, and to improve a practice's quality of care.

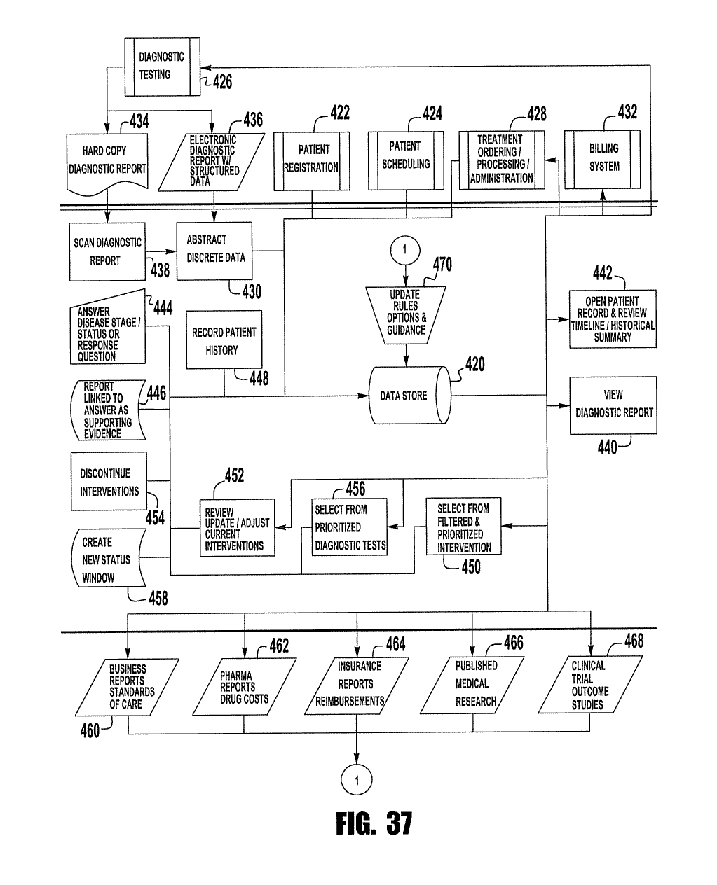

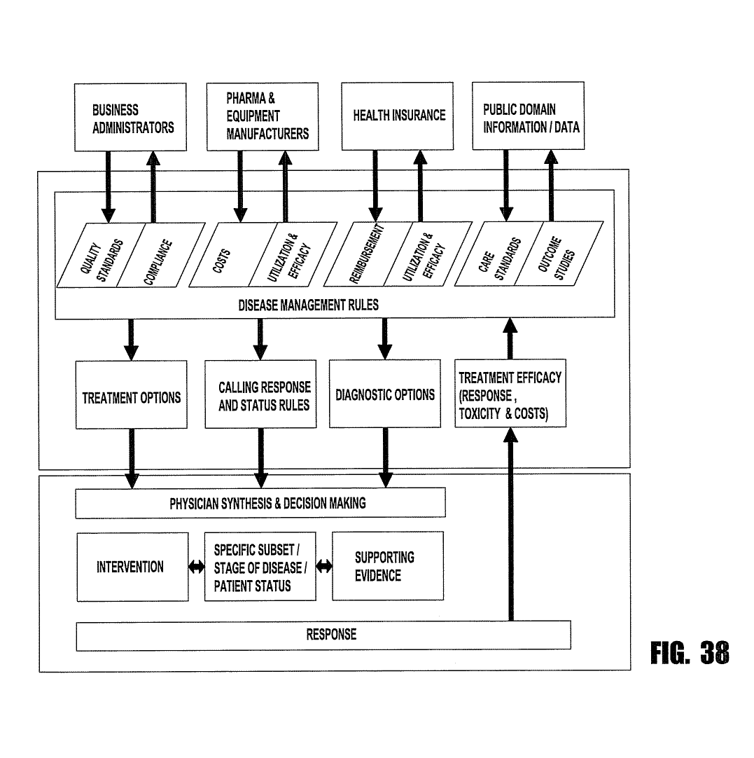

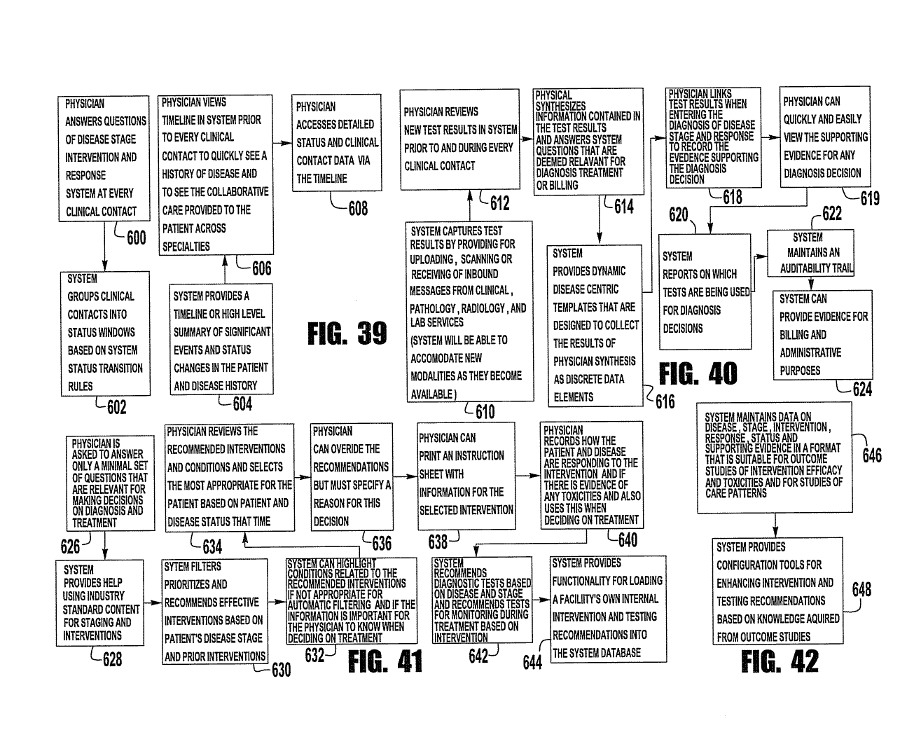

FIGS. 39-42 illustrate flowcharts of methods performed according to various embodiments of the present invention. At 600 in FIG. 39, a healthcare provider answers questions relating to a disease, stage of the disease, intervention(s) and a response of the patient to the intervention(s) at every clinical contact with the patient. At 602, the clinical contacts are grouped into status windows based on, for example, status transition rules. At 604, a clinical event-based progression (e.g., a forward or backward transition from one status to another status), series, order, sequence, and/or timeline is provided. At 606, the healthcare provider views the event-based sequence from 604 prior to every clinical contact in order to gauge the history of the patient's disease and to see the collaborative health care that the patient is receiving across various specialties. At 608, the healthcare provider can access detailed status and clinical contact data via the event-based sequence.

At 610 in FIG. 40, test results are captured by uploading, scanning, receiving, etc. of inbound messages from clinical, pathology, radiology, lab services, etc. At 612, the healthcare provider reviews new test results prior to and during every clinical contact with the patient. At 614, the healthcare provider synthesizes information contained in the test results and answers questions that are deemed relevant for diagnosis, treatment, billing, etc. At 616, dynamic disease-centric templates are provided that are designed to collect the results of the synthesis from 614 as discrete data elements. At 618, the healthcare provider links test results, when entering the diagnosis of disease, stage and response to record the evidence supporting the diagnosis decision. At 619, the healthcare provider views the supporting evidence for any diagnosis decision and at 620 the tests that are being used for diagnosis decisions are reported. At 622, an audit trail is maintained and at 624 evidence for billing, administrative, etc. purposes is provided.

At 626 in FIG. 41, the healthcare provider is asked to answer a minimal set of questions that are relevant for making decisions on diagnosis and treatment. At 628, help using industry standard content for staging and interventions is provided. At 630, effective interventions are filtered, prioritized and recommended based on patient's disease, stage and prior interventions. At 632, conditions related to recommended interventions are highlighted. At 634, the healthcare provider reviews the recommended interventions and conditions and selects the most appropriate for the patient based on patient and disease status at the time. At 636, the healthcare provider can override the recommendations but, in one embodiment, must specify a reason for the decision. At 638, the healthcare provider can print an instruction sheet with information for the selected intervention.

At 640, the healthcare provider records how the patient and disease are responding to the intervention, and if there is evidence of toxicities, and also uses this when deciding on treatment. At 642, diagnostic tests are recommended based on disease and stage, and tests are recommended based on intervention. At 644, a facility's own internal intervention and testing recommendations may be entered into a database.

At 646 in FIG. 42, data is maintained on disease, stage, intervention, response, status and supporting evidence in a format that is suitable for outcome studies of intervention efficacy and toxicity, and for studies of care patterns. At 648, configuration tools enhance intervention and testing recommendations based on knowledge acquired from outcome studies.

The information management system can be implemented using computers and other devices programmed to perform the functions described above. Various software or firmware modules can be used to manipulate and store the information and data processed in the models. While embodiments of the invention have been described in terms of several examples, it will be apparent to those skilled in the art that various changes can be made to the described examples without departing from the scope of the invention as set forth in the following claims.

Various embodiments of the present invention may be implemented on computer-readable media. The terms “computer-readable medium” and “computer-readable media” in the plural as used herein may include, for example, magnetic and optical memory devices such as diskettes, compact discs of both read-only and writeable varieties, optical disk drives, hard disk drives, etc. A computer-readable medium may also include memory storage that can be physical, virtual, permanent, temporary, semi-permanent and/or semi-temporary. A computer-readable medium may further include one or more data signals transmitted on one or more carrier waves. While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention.

What is claimed is:

1. A computer-assisted method of assisting a health care provider in diagnosing and treating a patient, the method comprising:
preparing an event-based sequence relating to a disease for which the patient is diagnosed and treated;
accepting answers from the health care provider during at least one clinical contact with the patient to a plurality of questions relating to the disease, a stage of the disease, an intervention of the disease, and a response to the intervention; and
segmenting the event-based sequence into a plurality of milestone events for use by the health care provider in diagnosing and treating the patient.

2. The method of claim 1, further comprising creating at least one status window relating to the at least one clinical contact, wherein the at least one status window is created based on a computer-assisted decision process.

3. The method of claim 2, wherein the computer-assisted decision process uses at least one rule that is defined by a programmable rules engine.

4. The method of claim 2, wherein the at least one status window is created when a change to at least one of the answers is made.

5. The method of claim 2, further comprising establishing at least one boundary of data relevant to the patient.

6. The method of claim 1, wherein the event-based sequence is a timeline.

7. The method of claim 1, further comprising grouping a plurality of sets of activities that are specific to a status of the disease.

8. The method of claim 1, further comprising organizing a plurality of data relating to the disease, the stage of the disease, the intervention of the disease, and the response to the intervention using the event-based sequence.

9. The method of claim 1, further comprising graphically displaying the milestone events to the health care provider.

10. The method of claim 2, wherein the at least one status window highlights the at least one clinical contact when there is a significant change in the disease, the stage of the disease, the intervention of the disease, and the response to the intervention.

11. The method of claim 1, wherein segmenting the event-based sequence includes heuristically segmenting the event-based sequence into a sequenced format.

12. The method of claim 2, wherein the status window displays information relating to the disease, the stage of the disease, the intervention of the disease, and the response to the intervention.

13. The method of claim 2, wherein the status window displays a relevance of at least one care event and data relating to at least one diagnostic procedure.

14. The method of claim 3, further comprising hierarchically organizing, by the programmable rules engine, at least one structured data field that is derived from at least one instrument reading, diagnostic interpretation, or observation by the health care provider.

15. A system, comprising:
a data store; and
a decision engine in communication with the data store, wherein the decision engine is configured to:
accept answers from a health care provider during at least one clinical contact with a patient to a plurality of questions relating to a disease, a stage of the disease, and a response to a first intervention;
accept external data; and
present at least one of a second intervention and a diagnostic test to the health care provider based on the answers and the external data.

16. The system of claim 15, wherein the decision engine is one of a logic engine and a rules engine.

17. A system, comprising:
means for preparing an event-based sequence relating to a disease for which a patient is diagnosed and treated;
means for accepting answers from a health care provider during at least one clinical contact with the patient to a plurality of questions relating to the disease, a stage of the disease, an intervention of the disease, and a response to the intervention; and
segmenting the event-based sequence into a plurality of milestone events for use by the health care provider in diagnosing and treating the patient.

18. A computer readable medium having stored thereon instructions which, when executed by a processor, cause the processor to:
prepare an event-based sequence relating to a disease for which a patient is diagnosed and treated;
accept answers from a health care provider during at least one clinical contact with the patient to a plurality of questions relating to the disease, a stage of the disease, an intervention of the disease, and a response to the intervention; and
segment the event-based sequence into a plurality of milestone events for use by the health care provider in diagnosing and treating the patient.

19. A computer-assisted method of assisting a health care provider in diagnosing and treating a patient, the method comprising:
receiving a plurality of diagnostic results relating to a disease for which the patient has been diagnosed, wherein the results are received from one of a clinical diagnostic, a pathological diagnostic, a radiological diagnostic and a laboratory diagnostic; and
categorizing the diagnostic results into a plurality of categories of supporting evidence.

20. The method of claim 19, further comprising displaying the categorized diagnostic results for use by the health care provider.

21. The method of claim 19, further comprising presenting a plurality of questions to the health care provider, wherein the questions relate to at least one of diagnosis of the disease, treatment of the disease and billing for services rendered.

22. The method of claim 19, further comprising generating at least one dynamic template based on the diagnostic results.

23. The method of claim 22, further comprising facilitating customizing, by the health care provider, the at least one dynamic template.

24. The method of claim 19, further comprising inputting the diagnostic results into a programmable rules engine.

25. The method of claim 19, further comprising linking at least one of the diagnostic results to a diagnosis of the disease, a stage of the disease, and a response to an intervention to create the supporting evidence.

26. The method of claim 19, further comprising displaying the supporting evidence to the health care provider.

27. The method of claim 25, further comprising displaying the at least one of the diagnostic results.

28. The method of claim 19, further comprising generating a billing statement.

29. The method of claim 19, further comprising generating an audit trail relating to a quality of care provided to the patient.

30. A system, comprising:
means for receiving a plurality of diagnostic results relating to a disease for which a patient has been diagnosed, wherein the results are received from one of a clinical diagnostic, a pathological diagnostic, a radiological diagnostic and a laboratory diagnostic; and
means for categorizing the diagnostic results into a plurality of categories of supporting evidence.

31. A computer readable medium having stored thereon instructions which, when executed by a processor, cause the processor to:
receive a plurality of diagnostic results relating to a disease for which a patient has been diagnosed, wherein the results are received from one of a clinical diagnostic, a pathological diagnostic, a radiological diagnostic and a laboratory diagnostic; and categorize the diagnostic results into a plurality of categories of supporting evidence.

32. A computer-assisted method of assisting a health care provider in diagnosing and treating a patient, the method comprising:
presenting a minimal set of questions to the health care provider, wherein at least one of the questions relates to a status of the patient, and wherein the questions are formulated based on relevancy;
accepting answers from the health care provider to the questions; and
dynamically formulating the questions based on at least one of the answers to a previous at least one of the questions.

33. The method of claim 32, further comprising determining if an abnormality that may influence a treatment of the patient exists.

34. The method of claim 32, further comprising updating information from at least one reference source that is used to formulate the questions.

35. The method of claim 32, further comprising presenting a set of the answers based on at least one of an intervention category, a disease of the patient, and a stage of the disease.

36. The method of claim 32, further comprising recommending an intervention to the health care provider, wherein the intervention is based on at least one of a disease of the patient and a stage of the disease.

37. The method of claim 36, wherein recommending is based on a plurality of rules.

38. The method of claim 37, wherein the rules are contextualized.

39. The method of claim 37, wherein the rules are configured to provide an audit trail that justifies the intervention.

40. The method of claim 36, further comprising informing the health care provider of at least one condition associated with the intervention.

41. The method of claim 36, wherein the intervention is selected from a list of interventions.

42. The method of claim 41, further comprising generating the list of interventions.

43. The method of claim 42, further comprising specifying, by the health care provider, at least one condition that is used to generate the list of interventions.

44. The method of claim 42, further comprising grouping the interventions on the list of interventions into at least one category.

45. The method of claim 41, wherein the interventions on the list of interventions are weighted by at least one of an expected insurance reimbursement and an expected intervention efficacy.

46. The method of claim 41, further comprising prioritizing the interventions on the list of interventions.

47. The method of claim 46, further comprising alerting the health care provider to follow the results of the prioritizing.

48. The method of claim 32, further comprising selecting, by the health care provider, an intervention, wherein the intervention is based on at least one of a disease of the patient and a stage of the disease.

49. The method of claim 48, further comprising determining whether the intervention is a recommended intervention.

50. The method of claim 48, further comprising obtaining, from the health care provider, a reason for selection of the intervention when the intervention is not a recommended intervention.

51. The method of claim 48, further comprising generating, by the health care provider, an order that contains information about the intervention.

52. The method of claim 32, further comprising generating a list of toxicity information for a plurality of interventions.

53. The method of claim 32, further comprising recording, by the health care provider, at least one of a response of a disease to a treatment and a response of the patient to the treatment.

54. The method of claim 52, further comprising using the toxicity information as guidance to select one of the interventions.

55. The method of claim 32, further comprising recommending at least one diagnostic test based on at least one of a disease of the patient and a stage of the disease.

56. The method of claim 32, further comprising storing information relating to at least one of an intervention and a testing recommendation.

57. The method of claim 38, further comprising linking to the contextualized rules.

58. The method of claim 37, wherein the rules are configured to require that a piece of evidence is present in order to recommend the intervention.

59. The method of claim 37, further comprising defining the rules.

60. The method of claim 58, further comprising specifying, by the rules, a composition of the piece of evidence.

61. A system, comprising:
a data store; and
a decision engine in communication with the data store, wherein the decision engine is configured to:
present a minimal set of questions to a health care provider, wherein at least one of the questions relates to a status of a patient, and wherein the questions are formulated based on relevancy;
accept answers from the health care provider to the questions; and
dynamically formulate the questions based on at least one of the answers to a previous at least one of the questions.

62. A system, comprising:
means for presenting a minimal set of questions to a health care provider, wherein at least one of the questions relates to a status of a patient, and wherein the questions are formulated based on relevancy;
means for accepting answers from the health care provider to the questions; and
means for dynamically formulating the questions based on at least one of the answers to a previous at least one of the questions.

63. A computer readable medium having stored thereon instructions which, when executed by a processor, cause the processor to:
present a minimal set of questions to a health care provider, wherein at least one of the questions relates to a status of a patient, and wherein the questions are formulated based on relevancy;
accept answers from the health care provider to the questions; and
dynamically formulate the questions based on at least one of the answers to a previous at least one of the questions.

64. A computer-assisted method of assisting a health care provider in diagnosing and treating a patient, the method comprising:
storing information relating to a disease of the patient, a stage of the disease, an intervention, a response to the intervention, a status of the disease, and supporting evidence; and
performing, based on the information, an outcome study of one of an efficacy of the intervention, a toxicity of the intervention, and a care pattern.

65. The method of claim 64, further comprising enhancing the intervention based on the information.

66. The method of claim 65, wherein the enhancing includes enhancing at least one rule that is used to select the intervention.

67. A system, comprising:
means for storing information relating to a disease of a patient, a stage of the disease, an intervention, a response to the intervention, a status of the disease, and supporting evidence; and
means for performing, based on the information, an outcome study of one of an efficacy of the intervention, a toxicity of the intervention, and a care pattern.

68. A computer readable medium having stored thereon instructions which, when executed by a processor, cause the processor to:
store information relating to a disease of a patient, a stage of the disease, an intervention, a response to the intervention, a status of the disease, and supporting evidence; and
perform, based on the information, an outcome study of one of an efficacy of the intervention, a toxicity of the intervention, and a care pattern.
